(19) United States
(12) Patent Application Publication
(10) Pub. No.: US 2024/0396607 A1
(43) Pub. Date: Nov. 28, 2024

(54) EVENT-TRIGGERED REPORTING OF CHANNEL STATE INFORMATION

(71) Applicant: Lenovo (United States) Inc., Morrisville, NC (US)

(72) Inventor: Ahmed Hindy, Aurora, IL (US)

(73) Assignee: Lenovo (United States) Inc., Morrisville, NC (US)

(21) Appl. No.: 18/670,591

(22) Filed: May 21, 2024

Related U.S. Application Data
(60) Provisional application No. 63/468,330, filed on May 23, 2023.

(51) Int. Cl. H04B 7/06; H04L 1/1812; H04W 72/231

(52) U.S. Cl. CPC H04B 7/0626; H04B 7/0632; H04B 7/0639; H04L 1/1812; H04W 72/231

(57) ABSTRACT

Various aspects of the present disclosure relate to apparatuses and methods for event-triggered reporting of CSI. An example apparatus receives, from at least one network entity, a first signaling as a channel state information (CSI) reporting setting. The CSI reporting setting includes an indication that enables an event-triggered CSI reporting by the apparatus over an uplink channel. The event-triggered CSI reporting associated with a first set of report quantities. Values of the first set of report quantities are based on values of a second set of report quantities associated with a network-triggered CSI reporting by the apparatus. The apparatus also transmits a second signaling as a CSI report, the CSI report including the first set of CSI report quantities.

### RELATED APPLICATION

This application claims priority to U.S. Provisional Application Ser. No. 63/468,330 filed May 23, 2023 entitled “Event-Triggered Reporting of Channel State Information,” the disclosure of which is incorporated by reference herein in its entirety.

### TECHNICAL FIELD

The present disclosure relates to wireless communications, and more specifically to event-triggered reporting of channel state information (CSI).

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communication system, a UE can measure and report various information to a base station serving the UE. For example, the base station can configure the UE to collect information about one or more channels and to report the collected information in the form of one or more CSI reports.

### SUMMARY

The present disclosure relates to methods, apparatuses, and systems that support event-triggered reporting of CSI. By utilizing the described techniques, overhead associated with providing CSI feedback is significantly reduced, which reduces network congestion and conserves network resources (e.g., bandwidth). Furthermore, delays associated with providing timely CSI updates are significantly reduced, which improves reliability and reduces the latency of wireless communications by reducing errors (e.g., decoding errors) associated with CSI reporting delays. Aspects of the disclosure are directed to event-triggered CSI feedback based on UE-assisted signaling. Further aspects of the disclosure are directed to an enhanced CSI framework which enables reporting a partial CSI update of a first group of CSI report quantities that is a subset of a second group of CSI report quantities corresponding to a full CSI report. Further aspects of the disclosure are directed to a multi-resolution CSI reference signal (CSI-RS) transmission, where a first resolution of the CSI-RS transmission is associated with a full CSI report and a second resolution of the CSI-RS transmission is associated with a partial CSI update. Further aspects of the disclosure are directed to a mechanism for uplink resource allocation to support feeding back a partial CSI update, where resources associated with communicating the partial CSI update are significantly less than resources associated with communicating a full CSI report.

In some implementations of the method and apparatuses described herein, a UE receives from at least one network entity, a first signaling as a CSI reporting setting. The CSI reporting setting includes an indication that enables an event-triggered CSI reporting by the apparatus over an uplink channel. The event-triggered CSI reporting is associated with a first set of report quantities. Values of the first set of report quantities are based on values of a second set of report quantities associated with a network-triggered CSI reporting by the apparatus. Additionally, the UE transmits a second signaling as a CSI report, the CSI report including the first set of CSI report quantities.

Some implementations of the method and apparatuses described herein may further include the second signaling is transmitted over a configured set of physical resources associated with the uplink channel. Additionally or alternatively, the event-triggered CSI reporting is associated with a set of downlink (DL) CSI reference signals based on the CSI reporting setting. Additionally or alternatively, the DL CSI reference signals of the event-triggered CSI reporting correspond to a group of non-zero power (NZP) CSI-RS resources associated with the network-triggered CSI reporting. Additionally or alternatively, the group of NZP CSI-RS resources is configured with at least one of: a periodic time-domain configuration, or a semi-persistent time-domain configuration. Additionally or alternatively, a first subset of the DL CSI-RSs is associated with the event-triggered CSI reporting, and a second subset of the DL CSI-RSs is associated with the network-triggered CSI reporting. Additionally or alternatively, the first subset of the DL CSI-RSs and the second subset of the DL CSI-RSs are received in an alternating manner over a set of time units. Additionally or alternatively, the CSI reporting setting further comprises configuration information that enables the network-triggered CSI reporting. Additionally or alternatively, the indication comprises at least one of: a higher-layer configuration parameter in the CSI reporting setting; a higher-layer configuration parameter in a codebook configuration associated with the CSI reporting setting; a selection of a set of channel quality indicator (CQI) tables comprising at least two CQI tables; a report quantity of the CSI reporting setting; or an identification of an additional CSI reporting setting, the additional CSI reporting setting corresponding to the network-triggered CSI reporting. Additionally or alternatively, the CSI report is transmitted over at least one of: a physical uplink shared channel (PUSCH)based on aperiodic time-domain behavior reporting or semi-persistent time-domain behavior reporting; or a physical uplink control channel (PUCCH) based on periodic time-domain behavior reporting or semi-persistent time-domain behavior reporting.

Additionally or alternatively, an event associated with the event-triggered CSI reporting comprises a change of a value of at least one CSI report quantity of the second set of CSI report quantities; and the change of the value is indicated in the first set of report quantities. Additionally or alternatively, the first set of CSI report quantities includes a rank indicator (RI) value; and the second set of CSI report quantities includes a precoder matrix indicator (PMI) value and a CQI value. Additionally or alternatively, the first set of CSI report quantities includes a RI value; and the second set of CSI report quantities includes a PMI value and a CQI value. Additionally or alternatively, the first set of CSI report quantities includes a RI value and a CQI value; and the second set of CSI report quantities includes a PMI value. Additionally or alternatively, the first set of CSI report quantities includes a first subset of parameters of a PMI value; and the second set of CSI report quantities includes a second subset of the parameters of the PMI value. Additionally or alternatively, the CSI report of the event-triggered CSI reporting is multiplexed with a hybrid automatic repeat request-acknowledgement (HARQ-ACK) feedback signal over the uplink channel. Additionally or alternatively, the CSI report being multiplexed HARQ-ACK feedback signal is based on the HARQ-ACK feedback signal corresponding to a non-acknowledgement (NACK) signal value. Additionally or alternatively, the event-triggered CSI reporting is configured using at least one of a downlink control information (DCI) signal or a medium access control element (MAC-CE) signal. Additionally or alternatively, the event-triggered CSI reporting is configured with at least one of: a periodic time-domain configuration, or a semi-persistent time-domain configuration. Additionally or alternatively, a first subset of a set of CSI reporting occasions by the apparatus are associated with the event-triggered CSI reporting, and a second subset of the set of the CSI reporting occasions are associated with the network-triggered CSI reporting. Additionally or alternatively, the first subset of the set of the CSI reporting occasions and the second subset of the set of the CSI reporting occasions are transmitted in an alternating manner over a set of time units. Additionally or alternatively, the CSI report includes at least one part, a first of the at least one part including an indicator of whether the first set of CSI report quantities is present. Additionally or alternatively, the at least one part is two parts based on the indicator having a given value; and a second of the two parts includes the first set of CSI report quantities. Additionally or alternatively, the CSI reporting setting is configured to override one or more other CSI reporting settings received at the apparatus prior to the CSI reporting setting of the first signaling. Additionally or alternatively, a number of CSI processing units (CPUs) associated with the event-triggered CSI reporting is equal to a maximum number of CPUs available at the apparatus.

In some implementations of the method and apparatuses described herein, a network entity transmits a first signaling as a CSI reporting setting. The CSI reporting setting includes an indication that enables event-triggered CSI reporting by a user equipment (UE) over an uplink channel. The event-triggered CSI reporting is associated with a first set of report quantities. Values of the first set of report quantities are based on values of a second set of report quantities associated with network-triggered CSI reporting by the UE. The network entity also receives, from the UE, a second signaling as a CSI report that includes the first set of CSI report quantities.

Some implementations of the method and apparatuses described herein may further include the second signaling is received over a configured set of physical resources associated with the uplink channel. Additionally or alternatively, the event-triggered CSI reporting is associated with a set of DL CSI reference signals based on the CSI reporting setting. Additionally or alternatively, the DL CSI reference signals of the event-triggered CSI reporting correspond to a group of NZP CSI-RS resources associated with the network-triggered CSI reporting. Additionally or alternatively, the group of NZP CSI-RS resources is configured with at least one of: a periodic time-domain configuration, or a semi-persistent time-domain configuration. Additionally or alternatively, a first subset of the DL CSI-RSs is associated with the event-triggered CSI reporting, and a second subset of the DL CSI-RSs is associated with the network-triggered CSI reporting. Additionally or alternatively, the first subset of the DL CSI-RSs and the second subset of the DL CSI-RSs are received in an alternating manner over a set of time units. Additionally or alternatively, the CSI reporting setting further comprises configuration information that enables the network-triggered CSI reporting by the UE. Additionally or alternatively, the indication comprises at least one of: a higher-layer configuration parameter in the CSI reporting setting; a higher-layer configuration parameter in a codebook configuration associated with the CSI reporting setting; a selection of a set of CQI tables comprising at least two CQI tables; a report quantity of the CSI reporting setting; or an identification of an additional CSI reporting setting, the additional CSI reporting setting corresponding to the network-triggered CSI reporting.

Additionally or alternatively, the CSI report is received from the UE over at least one of: a PUSCH based on aperiodic time-domain behavior reporting or semi-persistent time-domain behavior reporting; or a PUCCH based on periodic time-domain behavior reporting or semi-persistent time-domain behavior reporting. Additionally or alternatively, an event associated with the event-triggered CSI reporting includes a change of a value of at least one CSI report quantity of a second set of CSI report quantities associated with the network-triggered reporting; and the change of the value is indicated in the first set of report quantities. Additionally or alternatively, the first set of CSI report quantities includes a CQI value; and the second set of CSI report quantities includes a PMI value and a RI value. Additionally or alternatively, the first set of CSI report quantities includes a RI value; and the second set of CSI report quantities includes a PMI value and a CQI value. Additionally or alternatively, the first set of CSI report quantities includes a RI value and a CQI value; and the second set of CSI report quantities includes a PMI value. Additionally or alternatively, the first set of CSI report quantities includes a first subset of parameters of a PMI value; and the second set of CSI report quantities includes a second subset of the parameters of the PMI value. Additionally or alternatively, the CSI report of the event-triggered CSI reporting is multiplexed with a HARQ-ACK feedback signal over the uplink channel. Additionally or alternatively, the CSI report being multiplexed with the HARQ-ACK feedback signal is based on the HARQ-ACK feedback signal corresponding to a NACK signal value. Additionally or alternatively, the event-triggered CSI reporting is configured using at least one of a DCI signal or a MAC-CE signal.

Additionally or alternatively, the event-triggered CSI reporting is configured with at least one of: a periodic time-domain configuration, or a semi-persistent time-domain configuration. Additionally or alternatively, wherein a first subset of a set of CSI reporting occasions is associated with the event-triggered CSI reporting by the UE, and a second subset of the set of the CSI reporting occasions is associated with the network-triggered CSI reporting by the UE. Additionally or alternatively, the first subset of the set of the CSI reporting occasions and the second subset of the set of the CSI reporting occasions are received in an alternating manner over a set of time units. Additionally or alternatively, the CSI report includes at least one part, a first of the at least one part including an indicator of whether the first set of CSI report quantities is present. Additionally or alternatively, the at least one part is two parts based on the indicator having a given value, wherein a second of the two parts includes the first set of CSI report quantities. Additionally or alternatively, the CSI reporting setting is configured to override one or more other CSI reporting settings transmitted to the UE prior to the CSI reporting setting of the first signaling. Additionally or alternatively, a number of CPUs associated with the event-triggered CSI reporting is equal to a maximum number of CPUs available at the UE.

### BRIEF DESCRIPTION OF THE DRAWINGS

FIG. 1 illustrates an example of a wireless communications system that supports event-triggered reporting of CSI in accordance with aspects of the present disclosure.

FIG. 2 illustrates an example of aperiodic trigger state defining a list of CSI report settings, as related to event-triggered CSI reporting in accordance with aspects of the present disclosure.

FIG. 3 illustrates an example of aperiodic trigger state that indicates the resource set and quasi co-located (QCL) information, as related to event-triggered CSI reporting in accordance with aspects of the present disclosure.

FIG. 4 illustrates an example of a RRC configuration for (a) a NZP-CSI-RS resource and (b) a CSI-IM resource, as related to event-triggered CSI reporting in accordance with aspects of the present disclosure.

FIG. 5 illustrates an example of a partial CSI omission for PUSCH-based CSI, as related to event-triggered CSI reporting in accordance with aspects of the present disclosure.

FIG. 6 illustrates an example of abstract syntax notation one (ASN-1) code for configuring an NZP-CSI-RS resource set, as related to event-triggered CSI reporting in accordance with aspects of the present disclosure.

FIG. 7 illustrates an example of tracking reference signal (TRS) configuration, as related to event-triggered CSI reporting in accordance with aspects of the present disclosure.

FIG. 8 illustrates an example of ASN-1 code for QCL information, as related to event-triggered CSI reporting in accordance with aspects of the present disclosure.

FIG. 9 illustrates an example of ASN-1 code for PDSCH-Config Information Element (IE), as related to event-triggered CSI reporting in accordance with aspects of the present disclosure.

FIG. 10 illustrates an example of ASN-1 code for DMRS-DownlinkConfig, as related to event-triggered CSI reporting in accordance with aspects of the present disclosure.

FIGS. 11A and 11B illustrate an example of DMRS patterns for mapping Type A with front-load DMRS, as related to event-triggered CSI reporting in accordance with aspects of the present disclosure.

FIG. 12 illustrates an example of ASN-1 code for an implementation that includes a radio resource control (RRC) parameter configured as a higher-layer parameter, which supports event-triggered reporting of CSI in accordance with aspects of the present disclosure.

FIG. 13 illustrates an example of ASN-1 code for an implementation that includes a RRC parameter configured within a codebook configuration, which supports event-triggered reporting of CSI in accordance with aspects of the present disclosure.

FIG. 14 illustrates an example of ASN-1 code for an implementation where an event-triggered CSI reporting setting is implicitly indicated by configuring values of a report quantity parameter, which supports event-triggered reporting of CSI in accordance with aspects of the present disclosure.

FIG. 15 illustrates an example of ASN-1 code for an implementation where an event-triggered CSI reporting setting is implicitly indicated by configuring an additional report quantity parameter, which supports event-triggered reporting of CSI in accordance with aspects of the present disclosure.

FIG. 16 illustrates an example of ASN-1 code for an implementation where an event-triggered CSI reporting setting is implicitly indicated by configuring values of a CQI parameter, which supports event-triggered reporting of CSI in accordance with aspects of the present disclosure.

FIG. 17 illustrates an example of ASN-1 code for an implementation where an event-triggered CSI reporting setting is implicitly indicated by configuring an additional CQI table parameter, which supports event-triggered reporting of CSI in accordance with aspects of the present disclosure.

FIGS. 18 and 19 illustrate an example of a block diagram of devices that supports event-triggered reporting of CSI in accordance with aspects of the present disclosure.

FIGS. 20 and 21 illustrate flowcharts of methods that support event-triggered reporting of CSI in accordance with aspects of the present disclosure.

### DETAILED DESCRIPTION

In a wireless communication system, CSI feedback is reported by a UE to facilitate optimizing network reliability and performance. The CSI feedback can take various forms such as by varying CSI format, frequency granularity, and/or time-domain behavior of the CSI feedback. Delays in reporting CSI updates to the network may result in physical downlink shared channel (PDSCH) decoding errors (i.e., reduced reliability) as well as additional PDSCH transmissions (i.e., reduced power efficiency per transport block (TB) due to HARQ-ACK based retransmissions). On the other hand, excessive CSI reporting may result in increased power consumption and network congestion.

In some scenarios, a UE may experience quick updates to its CSI status due to abrupt channel variations or bursts of interference. Generally, in scenarios where large variations in channel characteristics occur (e.g., due to high UE speed or haphazard interference bursts), coherence periods of a channel may be unequal. A conventional periodic CSI reporting approach may be inefficient in such scenarios due to gaps between consecutive reporting instances. For example, under a periodic or semi-persistent CSI reporting approach, CSI report quantities (e.g., PMI, RI, CQI, etc.) are fed back in a periodic manner. However, selecting a small CSI reporting periodicity to ensure timely reporting CSI updates may result in a large CSI feedback overhead; and selecting a large CSI reporting periodicity may result in a substantially large CSI mismatch due to the delay between consecutive reporting instances. Conventional aperiodic reporting approaches may also be inefficient in such scenarios. A conventional aperiodic CSI reporting approach typically involves CSI reporting that is triggered based on a network-monitored event (e.g., HARQ-ACK feedback), e.g., where a new CSI feedback report is triggered when a NACK signal is received. However, large delays could be incurred while waiting for the NACK signal to report the updated CSI feedback.

In aspects of event-triggered reporting of CSI, this disclosure describes details for event-triggered CSI feedback based on UE-assisted signaling to reduce the overhead and latency associated with reporting CSI feedback in a timely and resource-efficient manner. In further aspects of event-triggered reporting of CSI, an enhanced CSI framework is provided that supports partial CSI update reporting of a first group of CSI report quantities based on a second group of CSI report quantities corresponding to a full CSI report, where the first group of CSI report quantities is a subset of the second group of CSI report quantities for example. In further aspects of event-triggered reporting of CSI, a multi-resolution CSI-RS transmission is proposed, where a first resolution of the CSI-RS transmission is associated with a full CSI report, and a second resolution of the CSI-RS transmission is associated with a partial CSI update. In further aspects of event-triggered reporting of CSI, a mechanism for UL resource allocation to support feeding back a partial CSI update is provided, where resources associated with the partial CSI update are significantly less than resources associated with feeding back a full CSI report.

Aspects of the present disclosure are described in the context of a wireless communications system. Aspects of the present disclosure are further illustrated and described with reference to device diagrams and flowcharts.

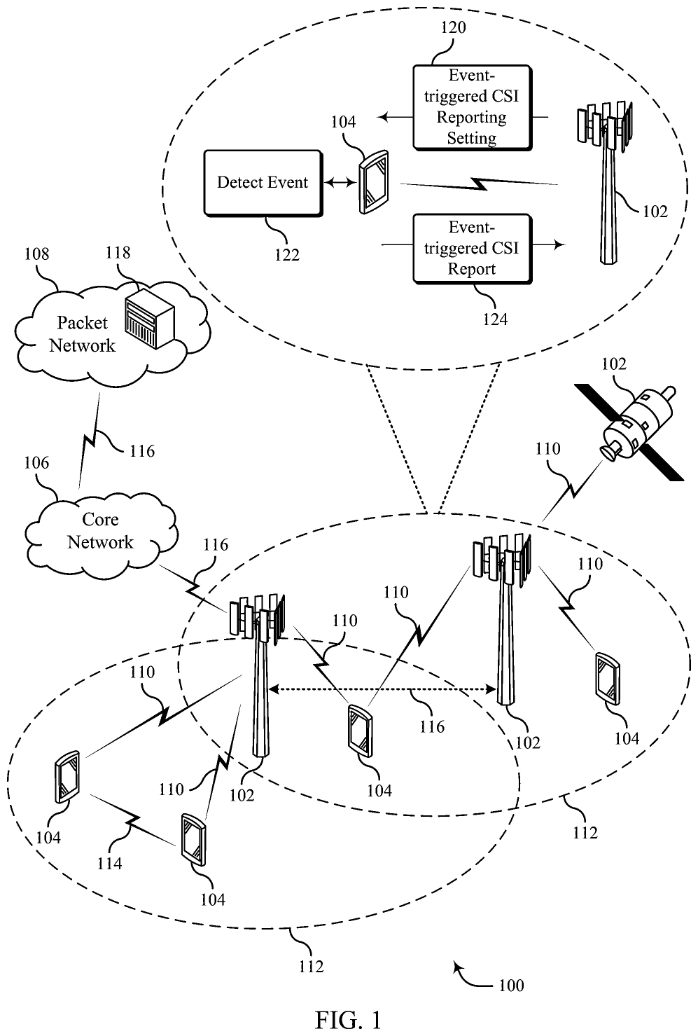

FIG. 1 illustrates an example of a wireless communications system 100 that supports event-triggered reporting of CSI in accordance with aspects of the present disclosure. The wireless communications system 100 may include one or more network entities (NEs) 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite (e.g., a non-terrestrial station (NTS)) associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 and the UEs 104 are operable to implement various aspects of event-triggered reporting of CSI, as described herein. For instance, a network entity 102 (e.g., a base station) communicates a first signaling 120 as an event-triggered CSI reporting setting that includes various information, such as conditions or events that the UE 104 is to monitor or use as a basis to trigger transmission of an event-triggered CSI report 124, resources to use when sending an event-triggered CSI report 124, time domain behavior of CSI reporting by the UE 104, information to be reported by the UE 104 in the event-triggered CSI report 124, and/or information to be reported by the UE 104 in a network-triggered CSI report. The UE 104 receives the event-triggered CSI reporting setting 120 and monitors one or more channels for a change or other detected event 122 to trigger sending a CSI report to the base station 102. Accordingly, the UE 104 generates and transmits a second signaling 124 as an event-triggered CSI report to the network entity 102 that indicates a first set of report quantities, generated according to a configuration indicated by the CSI reporting setting 120. In at least some implementations, the first set of report quantities is a subset of a second set of report quantities that the UE 104 is configured to send to the network entity 102 in a network-triggered CSI report (e.g., multiplexed with HARQ-ACK feedback, etc.).

With reference to NR codebook types and timing for CSI reporting, new radio (5GNR) codebook types are taken into consideration, such as Type-II Codebook. With reference to NR (Rel. 15) Type-II codebook, a gNB can be equipped with a two-dimensional (2D) antenna array with N₁, N₂ antenna ports per polarization placed horizontally and vertically, and communication occurs over N₃ PMI sub-bands. A PMI sub-band consists of a set of resource blocks, with each resource block consisting of a set of subcarriers. In this case, 2N₁N₂ CSI-RS ports are utilized to enable downlink channel estimation with high resolution for NR (Rel. 15) Type-II codebook. In order to reduce the uplink (UL) feedback overhead, a discrete Fourier transform (DFT)-based CSI compression of the spatial domain is applied to L dimensions per polarization, where L<N₁N₂. In the sequel, the indices of the 2L dimensions are referred as the spatial domain (SD) basis indices. The magnitude and phase values of the linear combination coefficients for each sub-band are fed back to the gNB as part of the CSI report. The 2N₁N₂×N₃ codebook per layer l takes on the form:

$${W}_{l} = {W}_{1} {W}_{2 , l} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ 1 {e}^{j \frac{2 π m}{{O}_{2} {N}_{2}}} ⋯ {e}^{j \frac{2 π m ( {N}_{2} - 1 )}{{O}_{2} {N}_{2}}} ] \\ {v}_{l , m} = {[ {u}_{m} {e}^{j \frac{2 π l}{{O}_{1} {N}_{1}}} {u}_{m} ⋯ {e}^{j \frac{2 π l ( {N}_{1} - 1 )}{{O}_{1} {N}_{1}}} {u}_{m} ]}^{T} \\ B = [ {v}_{{l}_{0} , {m}_{0}} {v}_{{l}_{1} , {m}_{1}} ⋯ {v}_{{l}_{L - 1} , {m}_{L - 1}} ] \\ {l}_{i} = {O}_{1} {n}_{1}^{( i )} + {q}_{1} , 0 \leq {n}_{1}^{( i )} < {N}_{1} , 0 \leq {q}_{1} < {O}_{1} , \\ {m}_{i} = {O}_{2} {n}_{2}^{( i )} + {q}_{2} , 0 \leq {n}_{2}^{( i )} < {N}_{2} , 0 \leq {q}_{2} < {O}_{2}$$

where the superscript^{T} denotes a matrix transposition operation. Note that O₁, O₂ oversampling factors are assumed for the 2D DFT matrix from which matrix B is drawn. Note that W₁ is common across all layers. W_{2,l} is a 2L×N₃ matrix, where the i^{th} column corresponds to the linear combination coefficients of the 2L beams in the i^{th} sub-band. Only the indices of the L selected columns of B are reported, along with the oversampling index taking on O₁O₂ values. Note that W_{2,l} are independent for different layers.

With reference to NR (Rel. 15) Type-II Port Selection codebook, only K (where K≤2N₁N₂) beamformed CSI-RS ports are utilized in a DL transmission, in order to reduce complexity. The K×N₃ codebook matrix per layer takes on the form:

$${W}_{l} = {W}_{1}^{PS} {W}_{2 , l} .$$

Here, W₂ follow the same structure as the conventional NR Type-II Codebook, and are layer specific. W₁^{PS} is a K×2L block-diagonal matrix with two identical diagonal blocks, i.e.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows:

$$E = [ {e}_{mod ( {m}_{PS} {d}_{PS} , K / 2 )}^{( K / 2 )} {e}_{mod ( {m}_{PS} {d}_{PS} + 1 , K / 2 )}^{( K / 2 )} ⋯ {e}_{mod ( {m}_{PS} {d}_{PS} + L - 1 , K / 2 )}^{( K / 2 )} ] ,$$

where eᵢ^{(K)} is a standard unit vector with a 1 at the i^{th} location. Here d_{PS} is an RRC parameter which takes on the values {1,2,3,4} under the condition d_{pS}≤min(K/2, L), whereas mₚs takes on the values

$$\{ 0 , … , ⌈ \frac{K}{2 {d}_{PS}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0,1, . . . ,7} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] ,$$

$$[ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0. \\ 0 & 0 & 0 & 0 \\ 1 & 0 & 0 & 0\end{matrix} ]$$

When d_{PS}=2, the 4 possible realizations of E corresponding to m_{PS}={0,1,2,3} are as

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

With reference to NR (Rel. 15) Type-I codebook, the Type-I codebook is the baseline codebook for NR, with a variety of configurations. The most common utility of the Type-I codebook is a special case of NR Type-II codebook with L=1 for RI=1,2, wherein a phase coupling value is reported for each sub-band, i.e., W_{2,l} is 2×N₃, with the first row equal to [1, 1, . . . , 1] and the second row equal to [e^{j2πØ}^{₀}, . . . , e^{j2πØ}^{_{N3−1}}]. Under specific configurations, ϕ₀=ϕ₁ . . . =ϕ, i.e., wideband reporting. For RI>2 different beams are used for each pair of layers. The NR Type-I codebook can be depicted as a low-resolution version of NR Type-II codebook with spatial beam selection per layer-pair and phase combining only.

With reference to NR (Rel. 16) Type-II codebook, a gNB can be equipped with a two-dimensional (2D) antenna array with N₁, N₂ antenna ports per polarization placed horizontally and vertically and communication occurs over N₃ PMI sub-bands. A PMI sub-band consists of a set of resource blocks, with each resource block consisting of a set of subcarriers. In this case, 2N₁N₂N₃ CSI-RS ports are utilized to enable DL channel estimation with high resolution for NR (Rel. 16) Type-II codebook. In order to reduce the UL feedback overhead, a DFT-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form:

$${W}_{l} = {W}_{1} {\tilde{W}}_{2 , l} {W}_{f , l}^{H} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ 1 {e}^{j \frac{2 π m}{{O}_{2} {N}_{2}}} ⋯ {e}^{j \frac{2 π m ( {N}_{2} - 1 )}{{O}_{2} {N}_{2}}} ] , \\ {v}_{l , m} = {[ {u}_{m} {e}^{j \frac{2 π l}{{O}_{1} {N}_{2}}} {u}_{m} ⋯ {e}^{j \frac{2 π l ( {N}_{1} - 1 )}{{O}_{1} {N}_{1}}} {u}_{m} ]}^{T} , \\ B = [ {v}_{{l}_{0} , {m}_{0}} {v}_{{l}_{1} , {m}_{1}} ⋯ {v}_{{l}_{L - 1} , {m}_{L - 1}} ] , \\ {l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript^{T} denotes a matrix transposition operation. Note that O₁, O₂ oversampling factors are assumed for the 2D DFT matrix from which matrix B is drawn. Note that W₁ is common across all layers. W_{f} is an N₃×M matrix (M<N₃) with columns selected from a critically-sampled size-N₃ DFT matrix, as follows:

$${W}_{f , l} = [ {f}_{{k}_{0}} {f}_{{k}_{1}} ⋯ {f}_{{K}_{M ′ - 1}} ] , 0 \leq {k}_{i} \leq {N}_{3} - 1 , \\ {f}_{k} = {[ 1 {e}^{- j \frac{2 π k}{{N}_{3}}} ⋯ {e}^{- j \frac{2 π k ( {N}_{3} - 1 )}{{N}_{3}}} ]}^{T} .$$

Only the indices of the L selected columns of B are reported, along with the oversampling index taking on O₁O₂ values. Similarly, for W_{f,l} only the indices of the M selected columns out of the predefined size-N₃ DFT matrix are reported. In the sequel the indices of the M dimensions are referred to as the selected frequency domain (FD) basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}₂, W_{f} are selected independent for different layers. Magnitude and phase values of an approximately β fraction of the 2LM available coefficients are reported to the gNB (p<1) as part of the CSI report. Coefficients with zero magnitude are indicated via a per-layer bitmap, with the strongest coefficient amplitude set to one, and an index of the strongest coefficient reported. No amplitude or phase information is explicitly reported for this coefficient. Amplitude and phase values of a maximum of [2βLM]−1 coefficients, compared with 2N₁N₂×N₃−1 coefficients of a theoretical design.

For the Type-II Port Selection codebook (Rel. 16), only K (where K≤2N₁N₂) beamformed CSI-RS ports are utilized in DL transmission, in order to reduce complexity. The K×N₃ codebook matrix per layer takes on the form:

$${W}_{l} = {W}_{1}^{PS} {\tilde{W}}_{2 , l} {W}_{f , l}^{H} .$$

Here, \tilde{W}_{2,l} and Wp follow the same structure as the conventional NR (Rel. 16) Type-II Codebook, where both are layer specific. The matrix W₁^{PS} is a K×2L block-diagonal matrix with the same structure as that in the NR (Rel. 15) Type-II Port Selection codebook.

The NR (Rel. 17) Type-II Port Selection codebook follows a similar structure as that of Rel. 15 and Rel. 16 port-selection codebooks, as follows:

$${W}_{1} = {\overline{W}}_{1}^{PS} {\tilde{W}}_{2 , l} {W}_{f , l}^{H} .$$

However, unlike Rel. 15 and Rel. 16 Type-II port-selection codebooks, the port-selection matrix \tilde{W}₁^{PS} supports free selection of the K ports, or more precisely the K/2 ports per polarization out of the N₁N₂ CSI-RS ports per polarization, i.e.,

$$⌈ {log}_{2} ( \begin{matrix}{N}_{1} {N}_{2} \\ K / 2\end{matrix} ) ⌉ bits$$

are used to identify the K/2 selected ports per polarization, wherein this selection is common across all layers. Here, \tilde{W}_{2,l} and W_{f,l} follow the same structure as the conventional NR Rel. 16 Type-II Codebook, however M is limited to 1,2 only, with the network configuring a window of size N={2,4} for M=2. Moreover, the bitmap is reported unless β=1 and the UE reports all the coefficients for a rank up to a value of two.

With reference to CSI reporting, the codebook report is partitioned into two parts based on the priority of information reported. Each part is encoded separately (Part 1 has a possibly higher code rate). Below, only the parameters for NR (Rel. 16) Type-II codebook are listed. With reference to the content of a CSI report, a Part 1 is RI+CQI+total number of coefficients. A Part 2 is SD basis indicator+FD basis indicator/layer+bitmap/layer+coefficient amplitude info/layer+coefficient phase info/layer+strongest coefficient indicator/layer. Furthermore, Part 2 CSI can be decomposed into sub-parts, each with different priority (higher priority information listed first). Such partitioning is required to allow dynamic reporting size for a codebook based on available resources in the UL phase. Additionally, Type-II codebook is based on aperiodic CSI reporting, and only reported in PUSCH via DCI triggering (one exception). Type-I codebook can be based on periodic CSI reporting (PUCCH) or semi-persistent CSI reporting (PUSCH or PUCCH) or aperiodic reporting (PUSCH).

With reference to reporting CSI report Part 2, note that multiple CSI reports may be transmitted with different priorities, as shown below in Table 1.

Note that the priority of the N_{Rep} CSI reports are based on the following: (1) a CSI report corresponding to one CSI reporting configuration for one cell may have higher priority compared with another CSI report corresponding to one other CSI reporting configuration for the same cell; (2) CSI reports intended to one cell may have higher priority compared with other CSI reports intended to another cell; (3) CSI reports may have higher priority based on the CSI report content (e.g., CSI reports carrying L1-reference signal received power (RSRP) information have higher priority); and (4) CSI reports may have higher priority based on their type (e.g., whether the CSI report is aperiodic, semi-persistent or periodic, and whether the report is sent via PUSCH or PUCCH, may impact the priority of the CSI report). In light of that, CSI reports may be prioritized as follows, where CSI reports with lower identifiers (IDs) have higher priority:

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

s: CSI reporting configuration index, and Mₛ: Maximum number of CSI reporting configurations
c: Cell index, and N_{cells}: Number of serving cells
k: 0 for CSI reports carrying L1-RSRP or L1-Signal-to-Interference-and-Noise Ratio, 1 otherwise
y: 0 for aperiodic reports, 1 for semi-persistent reports on PUSCH, 2 for semi-persistent reports on PUCCH, 3 for periodic reports.

TABLE 1
Priority Reporting Levels for Part 2 CSI.

Priority 0:
For CSI reports 1 to N_{Rep}, Group 0 CSI for CSI reports
configured as ‘typeII-r16’ or ‘typeII-PortSelection-r16’; Part 2
wideband CSI for CSI reports configured otherwise
Priority 1:
Group 1 CSI for CSI report 1, if configured as ‘typeII-r16’ or
‘typeII-PortSelection-r16’; Part 2 sub-band CSI of even
sub-bands for CSI report 1, if configured otherwise
Priority 2:
Group 2 CSI for CSI report 1, if configured as ‘typeII-r16’ or
‘typeII-PortSelection-r16’; Part 2 sub-band CSI of odd
sub-bands for CSI report 1, if configured otherwise
Priority 3:
Group 1 CSI for CSI report 2, if configured as ‘typeII-r16’ or
‘typeII-PortSelection-r16’; Part 2 sub-band CSI of even
sub-bands for CSI report 2, if configured otherwise
Priority 4:
Group 2 CSI for CSI report 2, if configured as ‘typeII-r16’ or
‘typeII-PortSelection-r16’. Part 2 sub-band CSI of odd
sub-bands for CSI report 2, if configured otherwise
.
.
.
Priority 2N_{Rep} − 1:
Group 1 CSI for CSI report N_{Rep}, if configured as ‘typeII-r16’
or ‘typeII-PortSelection-r16’; Part 2 sub-band CSI of even
sub-bands for CSI report N_{Rep}, if configured otherwise
Priority 2N_{Rep}:
Group 2 CSI for CSI report N_{Rep}, if configured as ‘typeII-r16’
or ‘typeII-PortSelection-r16’; Part 2 sub-band CSI of odd
sub-bands for CSI report N_{Rep}, if configured otherwise

With reference to triggering aperiodic CSI reporting on PUSCH, a UE needs to report the needed CSI information for the network using the CSI framework in NR (Rel. 15). The triggering mechanism between a report setting and a resource setting can be summarized as shown below in Table 2.

TABLE 2
Triggering mechanism between a report
setting and a resource setting.

| | | Periodic | | |
|---|---|---|---|---|
| | | CSI | SP CSI | AP CSI |
| | | reporting | reporting | Reporting |
| Time Domain | Periodic | RRC | MAC CE | DCI |
| Behavior of | CSI-RS | configured | (PUCCH) | |
| Resource | | | DCI (PUSCH) | |
| Setting | SP CSI-RS | Not | MAC CE | DCI |
| | | Supported | (PUCCH) | |
| | | | DCI (PUSCH) | |
| | AP CSI-RS | Not | Not | DCI |
| | | Supported | Supported | |

Moreover, all associated resource settings for a CSI report setting need to have the same time domain behavior. Periodic CSI-RS/interference management (IM) resource and CSI reports are assumed to be present and active once configured by radio resource control (RRC). Aperiodic and semi-persistent CSI-RS/IM resources and CSI reports are explicitly triggered or activated. For aperiodic CSI-RS/IM resources and aperiodic CSI reports, the triggering is performed jointly by transmitting a DCI format 0-1. Semi-persistent CSI-RS/IM resources and semi-persistent CSI reports are independently activated.

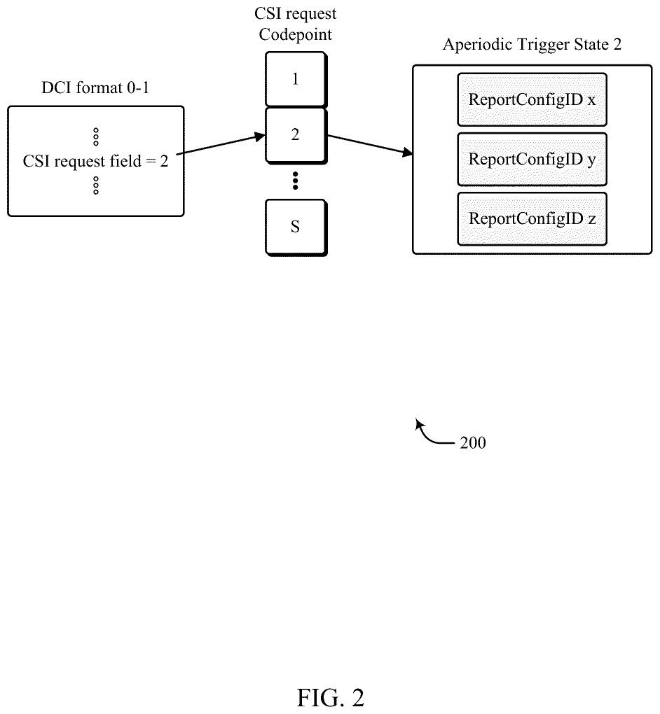

FIG. 2 illustrates an example 200 of aperiodic trigger state defining a list of CSI report settings as related to event-triggered CSI reporting in accordance with aspects of the present disclosure. In this example 200, for aperiodic CSI-RS/IM resources and aperiodic CSI reports, the triggering is performed jointly by transmitting a DCI format 0-1. The DCI format 0_1 contains a CSI request field (0 to 6 bits). A non-zero request field points to an aperiodic trigger state configured by RRC. An aperiodic trigger state in turn is defined as a list of up to sixteen (16) aperiodic CSI report settings, identified by a CSI report setting ID for which the UE calculates simultaneously CSI and transmits it on the scheduled PUSCH transmission.

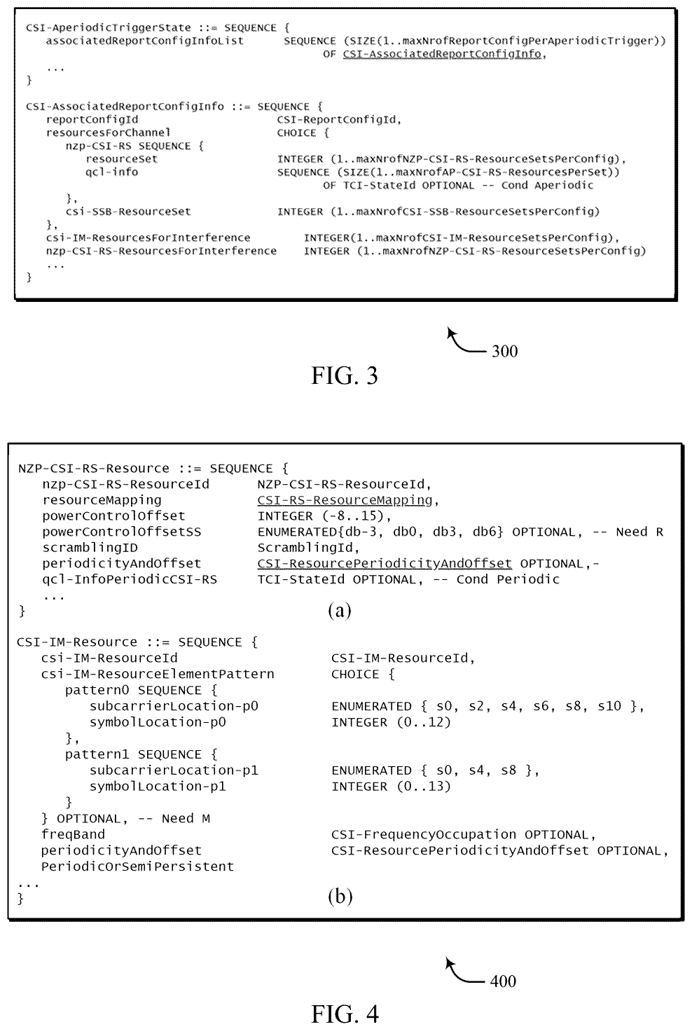

FIG. 3 illustrates an example 300 of aperiodic trigger state that indicates the resource set and QCL information as related to event-triggered CSI reporting in accordance with aspects of the present disclosure. This example 300 indicates that when the CSI report setting is linked with an aperiodic resource setting (which may include multiple resource sets), the aperiodic NZP-CSI-RS resource set for channel measurement, the aperiodic CSI-IM resource set (if used), and the aperiodic NZP-CSI-RS resource set for IM (if used) to use for a given CSI report setting are also included in the aperiodic trigger state definition, as shown in this example 300. For aperiodic NZP-CSI-RS, the QCL source to use is also configured in the aperiodic trigger state. The UE assumes that the resources used for the computation of the channel and interference can be processed with the same spatial filter (i.e. quasi-co-located with respect to “QCL-TypeD”).

FIG. 4 illustrates an example 400 of a RRC configuration for (a) an NZP-CSI-RS resource and (b) CSI-IM resource as related to event-triggered CSI reporting in accordance with aspects of the present disclosure. This example 400 indicates the RRC configuration for NZP-CSI-RS/CSI-IM resources. A Table 3 below summarizes the type of UL channels used for CSI reporting as a function of the CSI codebook type.

TABLE 3
UL channels used for CSI reporting as
a function of the CSI codebook type.

| | Periodic CSI | | AP CSI |
|---|---|---|---|
| | reporting | SP CSI reporting | reporting |
| Type I WB | PUCCH | PUCCH Format 2 | PUSCH |
| | Format 2, 3, 4 | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 only | | PUCCH Format 3, 4 | |

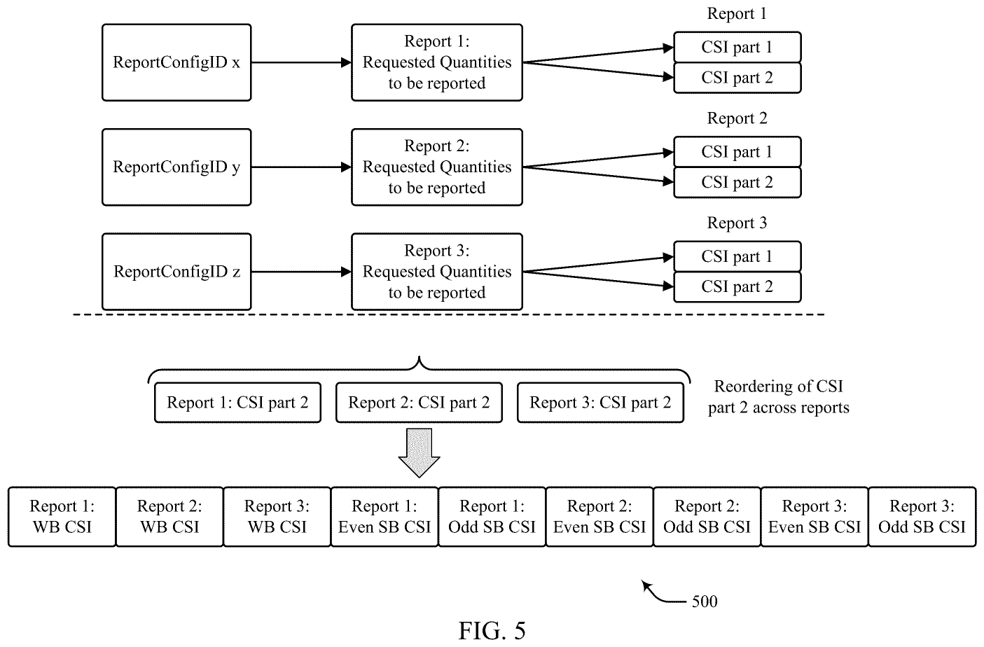

FIG. 5 illustrates an example 500 of a partial CSI omission for PUSCH-based CSI as related to event-triggered CSI reporting in accordance with aspects of the present disclosure. For aperiodic CSI reporting, PUSCH-based reports are divided into two CSI parts, CSI Part1 and CSI Part 2, because the size of CSI payload varies significantly, and therefore a worst-case uplink control information payload size design would result in large overhead. CSI Part 1 has a fixed payload size (and can be decoded by the gNB without prior information) and contains the following: RI (if reported), CSI-RS resource index (CRI) (if reported), and CQI for the first codeword; and a number of non-zero wideband amplitude coefficients per layer for Type II CSI feedback on PUSCH. CSI Part 2 has a variable payload size that can be derived from the CSI parameters in CSI Part 1 and contains PMI and the CQI for the second codeword when RI>4. For example, if the aperiodic trigger state indicated by DCI format 0_1 defines 3 report settings x, y, and z, then the aperiodic CSI reporting for CSI part 2 will be ordered as indicated in this example 500.

As described, CSI reports are prioritized according to several factors, including the time-domain behavior and physical channel, where more dynamic reports are given precedence over less dynamic reports and PUSCH has precedence over PUCCH; CSI content, where beam reports (i.e. L1-RSRP reporting) has priority over regular CSI reports; the serving cell to which the CSI corresponds (in case of carrier aggregation (CA) operation), and CSI corresponding to the PCell has priority over CSI corresponding to Scells; and the reportConfigID.

With reference to CQI reporting, a CSI report may include a CQI report quantity corresponding to channel quality assuming a maximum target transport block error rate, which indicates a modulation order, a code rate, and a corresponding spectral efficiency associated with the modulation order and code rate pair. Examples of the maximum transport block error rates are 0.1 and 0.00001. The modulation order can vary from quadrature phase-shift keying (QPSK) up to 1024QAM, whereas the code rate may vary from 30/1024 up to 948/1024. One example of a CQI table for a 4-bit CQI indicator that identifies a possible CQI value with the corresponding modulation order, code rate and efficiency is provided in Table 4 below.

A CQI value may be reported in two formats: a wideband format, wherein one CQI value is reported corresponding to each PDSCH transport block, and a sub-band format, where one wideband CQI value is reported for the entire transport block, in addition to a set of sub-band CQI values corresponding to CQI sub-bands on which the transport block is transmitted. CQI sub-band sizes are configurable, and depends on the number of PRBs in a bandwidth part, as shown in Table 5 below.

TABLE 4
Example of a 4-bit CQI table.

| | | | |
|---|---|---|---|
| CQI index | modulation | code rate × 1024 | efficiency |

| | |
|---|---|
| 0 | out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

TABLE 5
Configurable sub-band sizes for a
given bandwidth part (BWP) size.

| Bandwidth part (PRBs) | Sub-band size (PRBs) |
|---|---|
| 24-72 | 4, 8 |
| 73-144 | 8, 16 |
| 145-275 | 16, 32 |

If the higher layer parameter cqi-BitsPerSubband in a CSI reporting setting CSI-ReportConfig is configured, sub-band CQI values are reported in a full form (i.e., using 4 bits for each sub-band CQI based on a CQI table, e.g., Table 4). If the higher layer parameter cqi-BitsPerSubband in CSI-ReportConfig is not configured, for each sub-band s, a 2-bit sub-band differential CQI value is reported, defined as:

$$Sub - band Offset level ( s ) = sub - band CQI index ( s ) - wideband CQI index .$$

The mapping from the 2-bit sub-band differential CQI values to the offset level is shown in Table 6 below.

TABLE 6
Mapping sub-band differential CQI value to offset level.

| Sub-band differential CQI value | Offset level |
|---|---|
| 0 | 0 |
| 1 | 1 |
| 2 | ≥2 |
| 3 | ≤−1 |

In some implementations, multiple tables corresponding to mapping CQI indices to modulation and coding schemes may exist. For instance, Table 7 may correspond to a first CQI table with modulation and coding schemes that correspond to eMBB-based transmission, whereas Table 8 of the CQI may correspond to a first CQI table with modulation and coding schemes that correspond to URLLC-based transmission. Note that eMBB-based DL transmission and URLLC-based DL transmission correspond to two different thresholds of transport block error probability, wherein the threshold of the transport block error probability corresponding to the URLLC-based DL transmission, e.g., 0.00001 is lower than the threshold of the transport block error probability corresponding to the eMBB-based DL transmission, e.g., 0.1.

TABLE 7
CQI Table corresponding to eMBB-based DL transmission

| | | | |
|---|---|---|---|
| CQI index | modulation | code rate × 1024 | efficiency |

| | |
|---|---|
| 0 | out of range |

| | | | |
|---|---|---|---|
| 1 | QPSK | 78 | 0.1523 |
| 2 | QPSK | 193 | 0.3770 |
| 3 | QPSK | 449 | 0.8770 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |

TABLE 8
CQI Table corresponding to URLLC-based DL transmission.

| | | | |
|---|---|---|---|
| CQI index | modulation | code rate × 1024 | efficiency |

| | |
|---|---|
| 0 | out of range |

| | | | |
|---|---|---|---|
| 1 | QPSK | 30 | 0.0586 |
| 2 | QPSK | 50 | 0.0977 |
| 3 | QPSK | 78 | 0.1523 |
| 4 | QPSK | 120 | 0.2344 |
| 5 | QPSK | 193 | 0.3770 |
| 6 | QPSK | 308 | 0.6016 |
| 7 | QPSK | 449 | 0.8770 |
| 8 | QPSK | 602 | 1.1758 |
| 9 | 16QAM | 378 | 1.4766 |
| 10 | 16QAM | 490 | 1.9141 |
| 11 | 16QAM | 616 | 2.4063 |
| 12 | 64QAM | 466 | 2.7305 |
| 13 | 64QAM | 567 | 3.3223 |
| 14 | 64QAM | 666 | 3.9023 |
| 15 | 64QAM | 772 | 4.5234 |

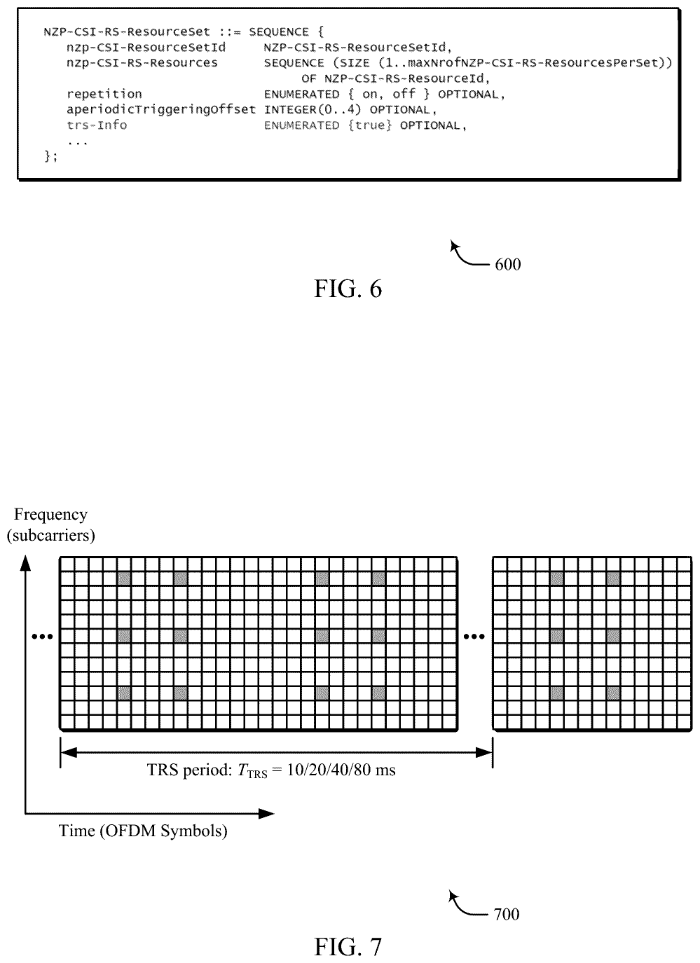

FIG. 6 illustrates an example 600 of ASN-1 code for configuring an NZP-CSI-RS resource set, as related to event-triggered CSI reporting in accordance with aspects of the present disclosure. Aspects of event-triggered CSI reporting include and/or are directed to TRS, which is transmitted for establishing fine time and frequency synchronization at a UE to aid in demodulation of PDSCH, particularly for higher order modulations. A TRS is an NZP-CSI-RS resource set with “TRS-info” set to true. As shown in the example 600, “trs-info” indicates that the antenna port for all NZP-CSI-RS resources in the CSI-RS resource set is the same. The TRS contains either 2 or 4 periodic CSI-RS resources with periodicity 2^{-μ}*Xp slots where Xp=10, 20, 40, or 80 and where is related to the sub carrier spacing, i.e., μ₌0, 1, 2, 3, 4 for 15, 30, 60,120,240 kHz, respectively. The slot offsets for the 2 or 4 CSI-RS resources are configured such that the first pair of resources are transmitted in one slot, and the 2nd pair (if configured) are transmitted in the next (adjacent) slot. All four resources are single port with density 3, as further shown in FIG. 7.

FIG. 7 illustrates an example 700 of TRS configuration, as related to event-triggered CSI reporting in accordance with aspects of the present disclosure. In this example 700, the two CSI-RS within a slot are always separated by four symbols in the time domain. This time-domain separation sets a limit for the maximum frequency error that can be compensated. Likewise, the frequency-domain separation of four subcarriers sets a limit for the maximum timing error that can be compensated. The maximum number of TRS a UE can be configured with is a UE capability. For example, the maximum number of TRS resource sets (per component carrier (CC)) that a UE is able to track simultaneously: Candidate value set {1 to 8}. The maximum number of TRS resource sets configured to UE per CC: Candidate value set: {1 to 64}. the UE is mandated to report at least 8 for FR1 and 16 for FR2. The maximum number of TRS resource sets configured to UE across CCs: Candidate value set: {1 to 256}. UE is mandated to report at least 16 for FR1 and 32 for FR2. Furthermore, an aperiodic TRS is a set of aperiodic CSI-RS for tracking that is optionally configured, but a periodic TRS always needs to be configured, and its time and frequency domain configurations (except for the periodicity) must match those of the periodic TRS. The UE may assume that the aperiodic TRS resources are quasi-co-located with the periodic TRS resources.

FIG. 8 illustrates an example 800 of ASN-1 code for QCL information, as related to event-triggered CSI reporting in accordance with aspects of the present disclosure. In this example 800, a transmission configuration indicator (TCI) state (in example 800 and as configured by RRC) will have two QCL types (i.e., two reference signals) with the second QCL type only for operation in FR2.

With reference to DMRS and reception of DMRS for PDSCH, QCL TypeA properties (Doppler shift, Doppler spread, average delay, delay spread) can be inferred from a periodic TRS. In turn for periodic TRS, QCL TypeC properties (Average delay, Doppler shift) can be inferred from a synchronization signal block (SSB). The DMRS is used to estimate channel coefficients for coherent detection of the physical channels. For downlink, the DMRS is subject to the same precoding as the PDSCH. NR first defines two time-domain structures for DMRS according to the location of the first DMRS symbol. For example, mapping Type A, where the first DMRS is located in the second and the third symbol of the slot, and the DMRS is mapped relative to the start of the slot boundary, regardless of where in the slot the actual data transmission occurs. Further, mapping Type B, where the first DMRS is positioned in the first symbol of the data allocation, that is, the DMRS location is not given relative to the slot boundary, rather relative to where the data are located.

The mapping of PDSCH transmission can be dynamically signaled as part of the DCI. Moreover, the DMRS has two types, Types 1 and 2, which are distinguished in frequency-domain mapping and the maximum number of orthogonal reference signals. Type 1 can provide up to four orthogonal signals using a single-symbol DMRS and up to eight orthogonal reference signals using a double-symbol DMRS. For four orthogonal signals, ports 1000 and 1001 use even-numbered subcarriers and are separated in the code domain within the code division multiplexing (CDM) group (length-2 orthogonal sequences in the frequency domain). Antenna ports 1000 and 1001 belong to CDM group 0, since they use the same subcarriers. Similarly, ports 1002 and 1003 belong to CDM group 1 and are generated in the same way using odd-numbered subcarriers. The DMRS Type 2 has a similar structure to Type 1, but Type 2 can provide 6 and 12 patterns depending on the number of symbols. Four subcarriers are used in each resource block and in each CDM group defining three CDM groups.

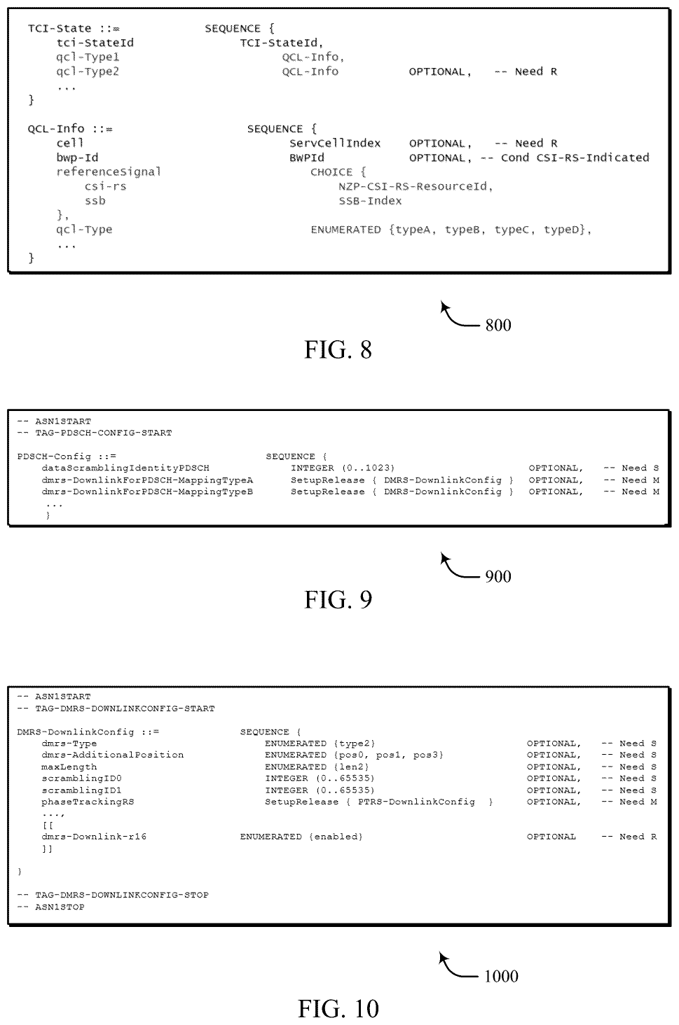

FIG. 9 illustrates an example 900 of ASN-1 code for PDSCH-Config IE, as related to event-triggered CSI reporting in accordance with aspects of the present disclosure. In this example 900, note that the configuration of the DMRS Type is provided through higher-layer signaling independently for each PDSCH and PUSCH, each mapping Type (A or B), and each BWP independently (see the RRC configuration). The PDSCH-Config IE, as shown in example 900, is used to configure the UE specific PDSCH parameters.

FIG. 10 illustrates an example 1000 of ASN-1 code for DMRS-DownlinkConfig, as related to event-triggered CSI reporting in accordance with aspects of the present disclosure. In this example 1000, the IE DMRS-DownlinkConfig is used to configure downlink demodulation reference signals for PDSCH.

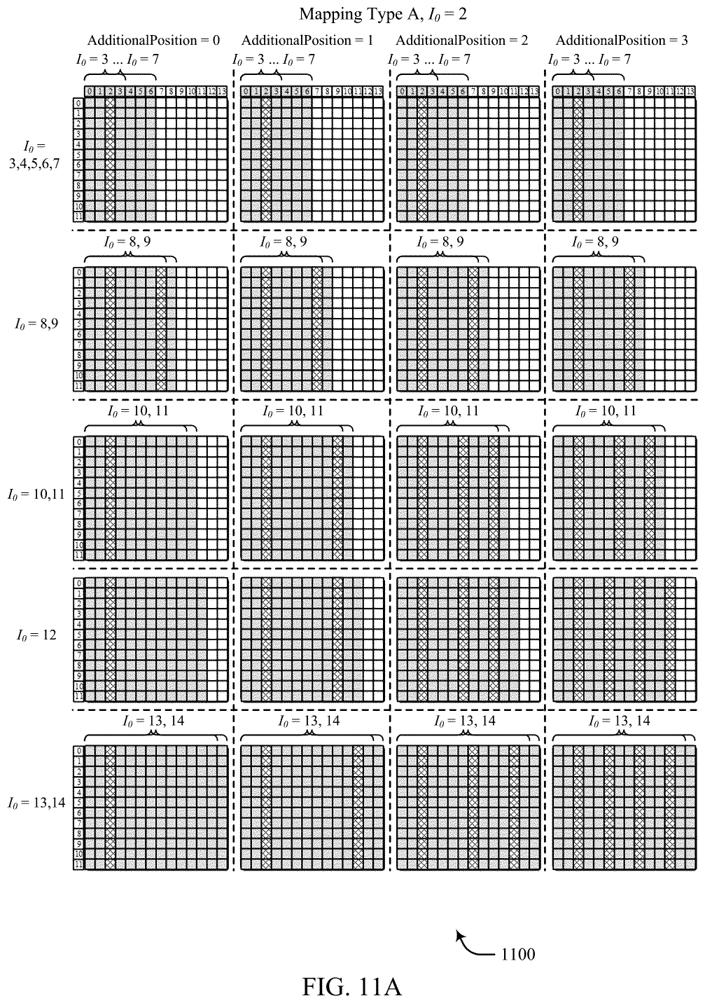

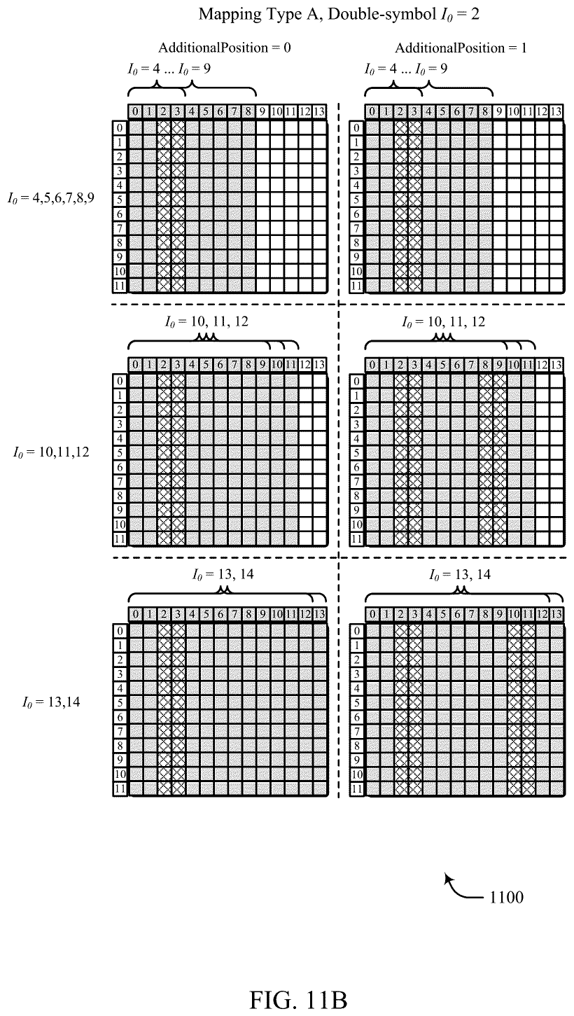

FIGS. 11A and 11B illustrate an example 1100 of DMRS patterns for mapping Type A with front-load DMRS, as related to event-triggered CSI reporting in accordance with aspects of the present disclosure. In this example 1100, the time domain mapping of the DMRS patterns can be decomposed to two parts. For example the first part defines the DMRS pattern used for the front-load DMRS, and then the second part defines a set of additional DMRS symbols inside the scheduled data channel duration which are either single-symbols, or double-symbols, depending on the length of the front-load DMRS. Inside the scheduled time-domain allocation of a PDSCH, the UE may expect up to 4 DMRS symbols. The location of the DMRS is defined by both higher-layer configuration and dynamic (DCI-based) signaling, such as dmrs-TypeA-Position, maxLength, and dmrs-AdditionalPosition. When double-symbol DMRS is used, there can be up to one more double-symbol DMRS (total 4 DMRS symbols inside the PDSCH allocation). Different DMRS patterns for mapping Type A with front-load DMRS are shown in the example 1100.

In the absence of CSI-RS configuration, and unless otherwise configured, the UE may assume PDSCH DMRS and synchronization signal (SS)/physical broadcast channel (PBCH) block antenna ports are quasi co-located with respect to Doppler shift, Doppler spread, average delay, delay spread, and spatial Rx parameters (if applicable). However, a CSI-RS for tracking can be used as a QCL reference (e.g., having larger bandwidth than an SS/PBCH block). Furthermore, the UE may assume that the PDSCH DMRS within the same CDM group are quasi co-located with respect to Doppler shift, Doppler spread, average delay, delay spread, and spatial Rx. The UE may then perform a joint estimation of DMRS ports which are CDMed using the same long-term statistics, and it is not required to measure, or use, different long-term statistics for different DMRS ports of the same PDSCH.

With reference to codeword-to-layer mapping, the UE may assume that complex-valued modulation symbols for each of the codewords to be transmitted are mapped onto one or several layers according to Table 9. Complex-valued modulation symbols d^{(q)}(0), . . . , d^{(q)}(M_{symb}^{(q)}−1) for codeword q may be mapped onto the layers x(i)=[x⁽⁰⁾(i) . . . x^{(ν-1)}(i)]^{T}, i=0,1, . . . , M_{symb}^{layer}−1 where ν is the number of layers and M_{symb}^{layer} is the number of modulation symbols per layer.

TABLE 9
Codeword-to-layer mapping for spatial multiplexing.

| Number | Number | | |
|---|---|---|---|
| of | of | Codeword-to-layer mapping | |
| layers | codewords | i = 0, 1, . . . , M_{symb}^{layer} −1 | |
| 1 | 1 | x⁽⁰⁾(i) = d⁽⁰⁾(i) | M_{symb}^{layer} = M_{symb}⁽⁰⁾ |
| 2 | 1 | x⁽⁰⁾(i) = d⁽⁰⁾(2i) | M_{symb}^{layer} = M_{symb}⁽⁰⁾/2 |
| | | x⁽¹⁾(i) = d⁽⁰⁾(2i + 1) | |
| 3 | 1 | x⁽⁰⁾(i) = d⁽⁰⁾(3i) | M_{symb}^{layer} = M_{symb}⁽⁰⁾/3 |
| | | x⁽¹⁾(i) = d⁽⁰⁾(3i + 1) | |
| | | x⁽²⁾(i) = d⁽⁰⁾(3i + 2) | |
| 4 | 1 | x⁽⁰⁾(i) = d⁽⁰⁾(4i) | M_{symb}^{layer} = M_{symb}⁽⁰⁾/4 |
| | | x⁽¹⁾(i) = d⁽⁰⁾(4i + 1) | |
| | | x⁽²⁾(i) = d⁽⁰⁾(4i + 2) | |
| | | x⁽³⁾(i) = d⁽⁰⁾(4i + 3) | |
| 5 | 2 | x⁽⁰⁾(i) = d⁽⁰⁾(2i) | M_{symb}^{layer} = M_{symb}⁽⁰⁾/ |
| | | x⁽¹⁾(i) = d⁽⁰⁾(2i + 1) | 2 = M_{symb}⁽¹⁾/3 |
| | | x⁽²⁾(i) = d⁽¹⁾(3i) | |
| | | x⁽³⁾(i) = d⁽¹⁾(3i + 1) | |
| | | x⁽⁴⁾(i) = d⁽¹⁾(3i + 2) | |
| 6 | 2 | x⁽⁰⁾(i) = d⁽⁰⁾(3i) | M_{symb}^{layer} = M_{symb}⁽⁰⁾/ |
| | | x⁽¹⁾(i) = d⁽⁰⁾(3i + 1) | 3 = M_{symb}⁽¹⁾/3 |
| | | x⁽²⁾(i) = d⁽⁰⁾(3i + 2) | |
| | | x⁽³⁾(i) = d⁽¹⁾(3i) | |
| | | x⁽⁴⁾(i) = d⁽¹⁾(3i + 1) | |
| | | x⁽⁵⁾(i) = d⁽¹⁾(3i + 2) | |
| 7 | 2 | x⁽⁰⁾(i) = d⁽⁰⁾(3i) | M_{symb}^{layer} = M_{symb}⁽⁰⁾/ |
| | | x⁽¹⁾(i) = d⁽⁰⁾(3i + 1) | 3 = M_{symb}⁽¹⁾/4 |
| | | x⁽²⁾(i) = d⁽⁰⁾(3i + 2) | |
| | | x⁽³⁾(i) = d⁽¹⁾(4i) | |
| | | x⁽⁴⁾(i) = d⁽¹⁾(4i + 1) | |
| | | x⁽⁵⁾(i) = d⁽¹⁾(4i + 2) | |
| | | x⁽⁶⁾(i) = d⁽¹⁾(4i + 3) | |
| 8 | 2 | x⁽⁰⁾(i) = d⁽⁰⁾(4i) | M_{symb}^{layer} = M_{symb}⁽⁰⁾/ |
| | | x⁽¹⁾(i) = d⁽⁰⁾(4i + 1) | 4 = M_{symb}⁽¹⁾/4 |
| | | x⁽²⁾(i) = d⁽⁰⁾(4i + 2) | |
| | | x⁽³⁾(i) = d⁽⁰⁾(4i + 3) | |
| | | x⁽⁴⁾(i) = d⁽¹⁾(4i) | |
| | | x⁽⁵⁾(i) = d⁽¹⁾(4i + 1) | |
| | | x⁽⁶⁾(i) = d⁽¹⁾(4i + 2) | |
| | | x⁽⁷⁾(i) = d⁽¹⁾(4i + 3) | |

With reference to antenna panels and/or ports, quasi-collocation, TCI state, and spatial relation. In some implementations, the terms antenna, panel, and antenna panel are used interchangeably. An antenna panel may be hardware that is used for transmitting and/or receiving radio signals at frequencies lower than 6 GHz (e.g., frequency range 1 (FR1)), or higher than 6 GHz (e.g., frequency range 2 (FR2)) or millimeter wave (mmWave). In some implementations, an antenna panel includes an array of antenna elements, where each antenna element is connected to hardware, such as a phase shifter that allows a control module to apply spatial parameters for transmission and/or reception of signals. The resulting radiation pattern is called a beam, which may or may not be unimodal and allows the device to amplify signals that are transmitted or received from spatial directions.

In one or more implementations, an antenna panel is virtualized as an antenna port in the specifications. An antenna panel can be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information is communicated via signaling or, in some implementations, capability information is provided to devices without a need for signaling. In the event that such information is available to other devices, it can be used for signaling or local decision making.

In one or more implementations, a device (e.g., a UE, a network node) antenna panel is a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel (or device panel) may be a logical entity with physical device antennas mapped to the logical entity. The mapping of physical device antennas to the logical entity can be based on device implementation. Communicating (e.g., receiving or transmitting) on at least a subset of antenna elements or antenna ports active for radiating energy (also referred to herein as active elements) of an antenna panel requires biasing or powering of the RF chain, which results in current drain or power consumption in the device associated with the antenna panel, including power amplifier and/or low noise amplifier power consumption associated with the antenna elements or antenna ports. The phrase “active for radiating energy,” as used herein is not meant to be limited to a transmit function, but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In one or more implementations, and depending on the particular device implementation, a device panel can have at least one of the following functionalities as an operational role: a unit of an antenna group to control its transmit beam independently, a unit of an antenna group to control its transmission power independently, and/or a unit of an antenna group to control its transmission timing independently. The device panel may be transparent to a gNB. For certain condition(s), a gNB or a network node can assume the mapping between the physical antennas of a device to the logical entity “device panel” may not be changed. For example, the condition may include until the next update or report from a device or include a duration of time over which the gNB assumes there will be no change to the mapping. A device may report its capability with respect to the device panel to the gNB or network. The device capability can include at least the number of device panels. In an implementation, the device may support UL transmission from one beam within a panel, and with multiple panels, more than one beam (e.g., one beam per panel) may be used for UL transmission. In another implementation, more than one beam per panel may be supported or used for UL transmission.

In some described implementations, an antenna port is defined such that the channel over which a symbol on the antenna port is conveyed can be inferred from the channel over which another symbol on the same antenna port is conveyed. Two antenna ports are QCL if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and/or spatial receive parameters. Two antenna ports may be quasi-located with respect to a subset of the large-scale properties, and a different subset of large-scale properties can be indicated by a QCL type. The QCL type can indicate which channel properties are the same between the two reference signals (e.g., on the two antenna ports). Thus, the reference signals can be linked to each other with respect to what the UE can assume about their channel statistics or QCL properties. For example, the QCL-type can be one of the following values: QCL-TypeA: {Doppler shift, Doppler spread, average delay, delay spread}; QCL-TypeB: {Doppler shift, Doppler spread}; QCL-TypeC: {Doppler shift, average delay}; QCL-TypeD: {Spatial Rx parameter}.

Spatial receive parameters can include one or more of angle of arrival (AoA,) dominant AoA, average AoA, angular spread, power angular spectrum (PAS) of AoA, average AoD (angle of departure), PAS of AoD, transmit and/or receive channel correlation, transmit and/or receive beamforming, spatial channel correlation, etc. The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission (i.e., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same receive beamforming weights).

As described in this disclosure, an antenna port may be a logical port that corresponds to a beam (resulting from beamforming), or may correspond to a physical antenna on a device. In one or more implementations, a physical antenna can map directly to a single antenna port, in which an antenna port corresponds to an actual physical antenna. Alternately, a set or subset of physical antennas, or an antenna set or antenna array or antenna sub-array, may be mapped to one or more antenna ports after applying complex weights, a cyclic delay, or both to the signal on each physical antenna. The physical antenna set may have antennas from a single module or panel, or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some described implementations, a TCI-state associated with a target transmission can indicate parameters for configuring a quasi-collocation relationship between the target transmission (e.g., a target RS of DMRS ports of the target transmission during a transmission occasion) and one or more source reference signals (e.g., SSB, CSI-RS, and/or sounding reference signal (SRS)) with respect to quasi co-location type parameters indicated in the corresponding TCI state. The TCI describes which reference signals are used as a QCL source, and what QCL properties can be derived from each reference signal. A device can receive a configuration of a plurality of transmission configuration indicator states for a serving cell for transmissions on the serving cell. In some of the described implementations, a TCI state includes at least one source RS to provide a reference (UE assumption) for determining QCL and/or a spatial filter.

In one or more implementations, spatial relation information associated with a target transmission can indicate parameters for configuring a spatial setting between the target transmission and a reference RS (e.g., SSB, CSI-RS, and/or SRS). For example, the device can transmit the target transmission with the same spatial domain filter used for reception of the reference RS (e.g., DL RS such as SSB or CSI-RS). In another example, the device may transmit the target transmission with the same spatial domain transmission filter used for the transmission of the reference RS (e.g., UL RS, such as SRS). A device can receive a configuration of multiple spatial relation information configurations for a serving cell for transmissions on the serving cell.

In some described implementations, an UL TCI state is provided if a device is configured with separate DL/UL TCI by RRC signaling. The UL TCI state can include a source reference signal which provides a reference for determining an UL spatial domain transmission filter for the UL transmission (e.g., dynamic-grant or configured-grant based PUSCH, dedicated PUCCH resources) in a CC, or across a set of configured CCs and/or BWPs.

In some described implementations, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides a QCL Type-D indication (e.g., for device-dedicated physical downlink control channel (PDCCH) and/or PDSCH) and is used to determine UL spatial transmission filter (e.g., for UE-dedicated PUSCH and/or PUCCH) for a CC, or across a set of configured CCs and/or BWPs. In an example, the UL spatial transmission filter is derived from the RS of DL QCL Type-D in the joint TCI state. The spatial setting of the UL transmission may be according to the spatial relation with a reference to the source RS configured with qcl-Type set to “typed” in the joint TCI state.

In aspects of event-triggered reporting of CSI, the following notations are used interchangeably, including network nodes, transmit-receive point (TRP), panel, set of antennas, set of antenna ports, uniform linear array, cell, node, radio head, communication (e.g., signals/channels) associated with a control resource set (CORESET), communication associated with a TCI state from a transmission configuration of at least two TCI states. The codebook type used for PMI reporting is arbitrary, and flexible in the use of different codebook types (e.g., Type-II Rel. 16 codebook, Type-II Rel. 17 codebook, Type-II Rel. 18 codebook, etc.). A TRS corresponds to an NZP-CSI-RS resource set with a parameter ‘trs-info’ being configured. A CSI-RS for beam management corresponds to an NZP-CSI-RS resource set with a parameter ‘repetition’ being configured. A CSI-RS for CSI corresponds to an NZP-CSI-RS resource set with neither parameters ‘trs-info’ nor ‘repetition’ being configured. A matrix implies a sequence of fields of an arbitrary dimension, including an array (vector) of values, a standard 2D matrix and more generally a Q-dimensional matrix (tensor), where Q≥2 and is an integer value. The terms “partial CSI update” and “event-triggered CSI report” are used interchangeably. The terms “full CSI report” and “network-triggered CSI report” are used interchangeably.

Aspects of the present disclosure include solutions for indication of event-triggered CSI reporting. In examples, a network configures a UE with reporting event-triggered CSI feedback, wherein the reporting of the event-triggered CSI feedback is conditioned on an event that is monitored by the UE based on one or more CSI-RS transmissions from the network. An indication of a configuration corresponding to enabling the UE to report event-triggered CSI feedback is in joint DL transmission can be a combination of one or more of the following implementations.

In a first implementation (e.g., new RRC parameter added in CSI reporting setting), a higher-layer parameter, e.g., Eventtriggered-mode, within the CSI-ReportConfig CSI Reporting Setting IE that configures the UE with event-triggered CSI feedback reporting. The higher-layer parameter may appear in different sub-elements of the Reporting Setting IE.

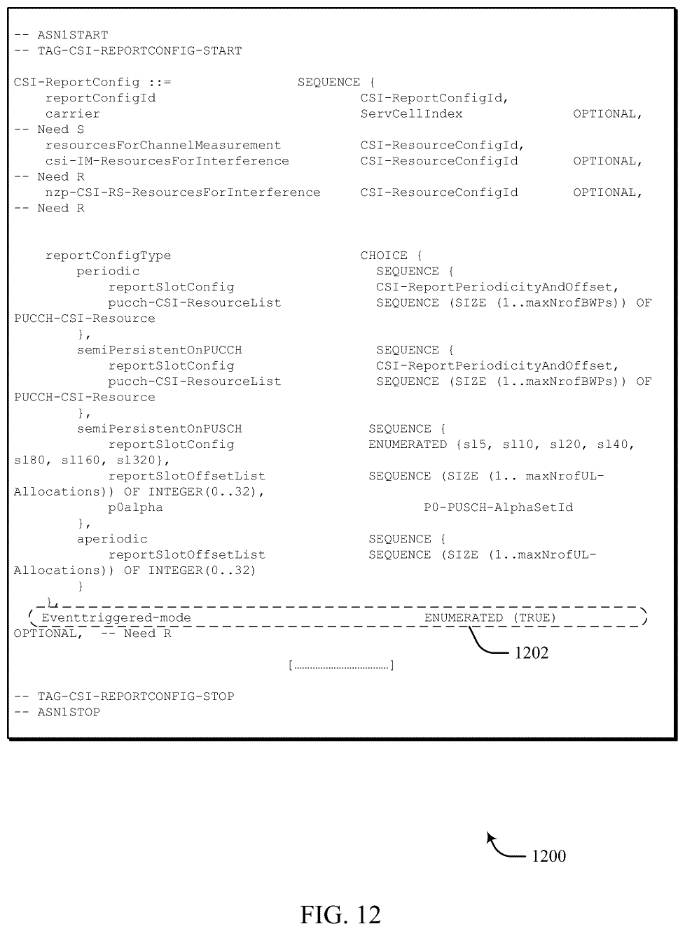

FIG. 12 illustrates an example 1200 of ASN-1 code for an implementation that includes a radio resource control (RRC) parameter configured as a higher-layer parameter 1202, which supports event-triggered reporting of CSI in accordance with aspects of the present disclosure. An example of the ASN.1 code that corresponds to the first implementation described above is provided in FIG. 12 for the CSI-ReportConfig Reporting Setting IE.

In a second implementation (e.g., new RRC parameter configured within a codebook configuration IE), a higher-layer parameter, e.g., Eventtriggered-mode, is configured within a codebook configuration (CodebookConfig) IE, e.g., CodebookConfig-r16, or CodebookConfig-r18. In alternate or additional examples, the new parameter is a sub-parameter within the higher-layer parameter codebookType, whenever the Codebook Type is set to ‘typeI-SinglePanel’.

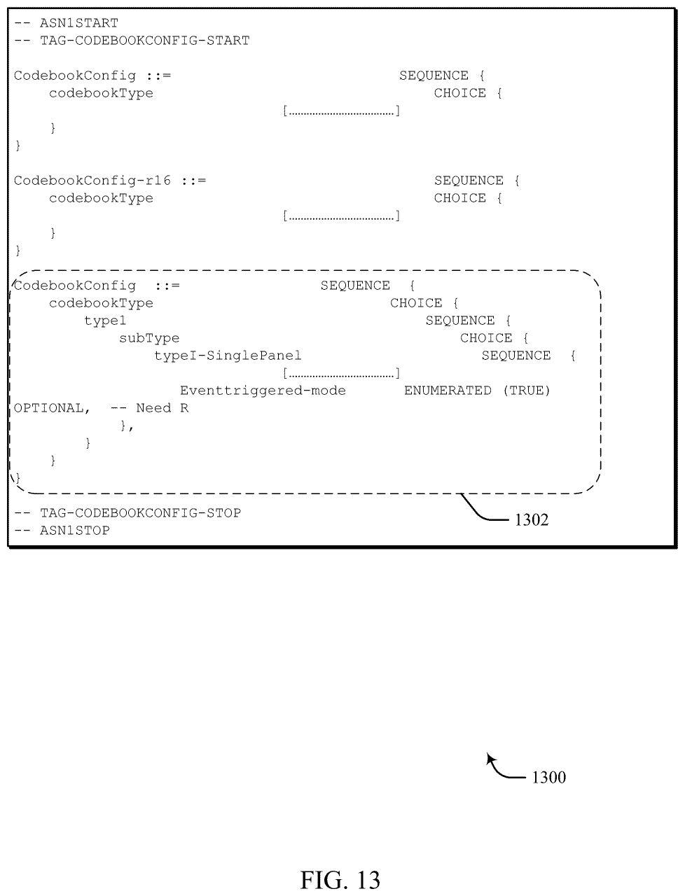

FIG. 13 illustrates an example 1300 of ASN-1 code for an implementation that includes a RRC parameter configured within a codebook configuration 1302, which supports event-triggered reporting of CSI in accordance with aspects of the present disclosure. An Example of the ASN.1 code that corresponds to the second implementation is provided in FIG. 13 for the CodebookConfig Codebook Configuration IE.

In a third implementation (e.g., implicit indication via selection of report quantity), the event-triggered CSI feedback reporting is indicated or inferred from a value of a higher-layer parameter corresponding to a report quantity of the CSI (e.g., reportQuantity).

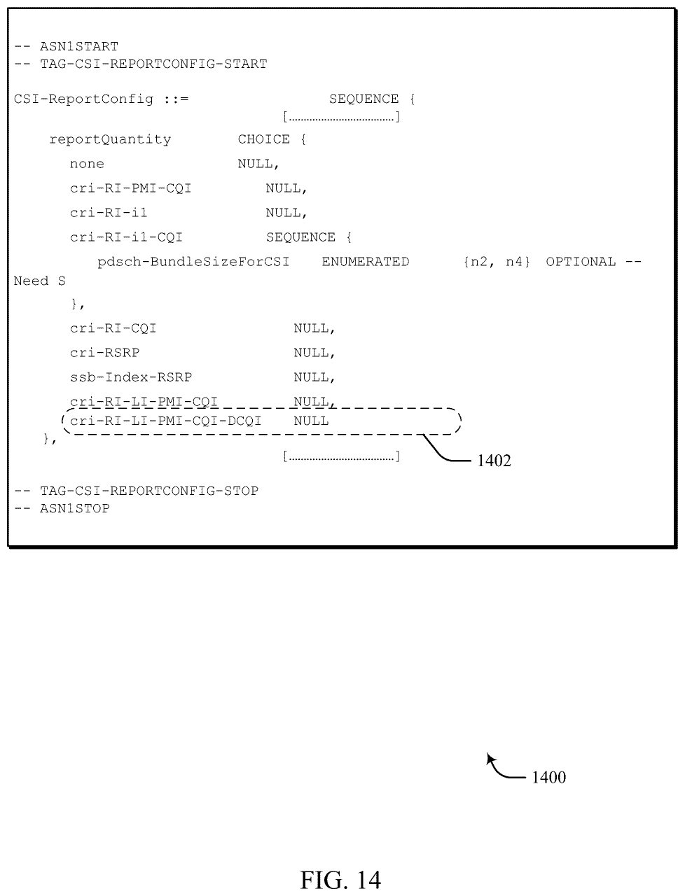

FIG. 14 illustrates an example 1400 of ASN-1 code for an implementation where an event-triggered CSI reporting setting is implicitly indicated by configuring values 1402 of a report quantity parameter, which supports event-triggered reporting of CSI in accordance with aspects of the present disclosure. In an example, a value of the higher-layer parameter reportQuantity that corresponds to a codepoint mapped to event-triggered CSI reporting (e.g., DCQI) corresponding to a delta CQI value associated with event-triggered CSI feedback reporting. An Example of the ASN.1 code that corresponds to this scenario is provided in FIG. 14 for the CSI-ReportConfig Reporting Setting IE.

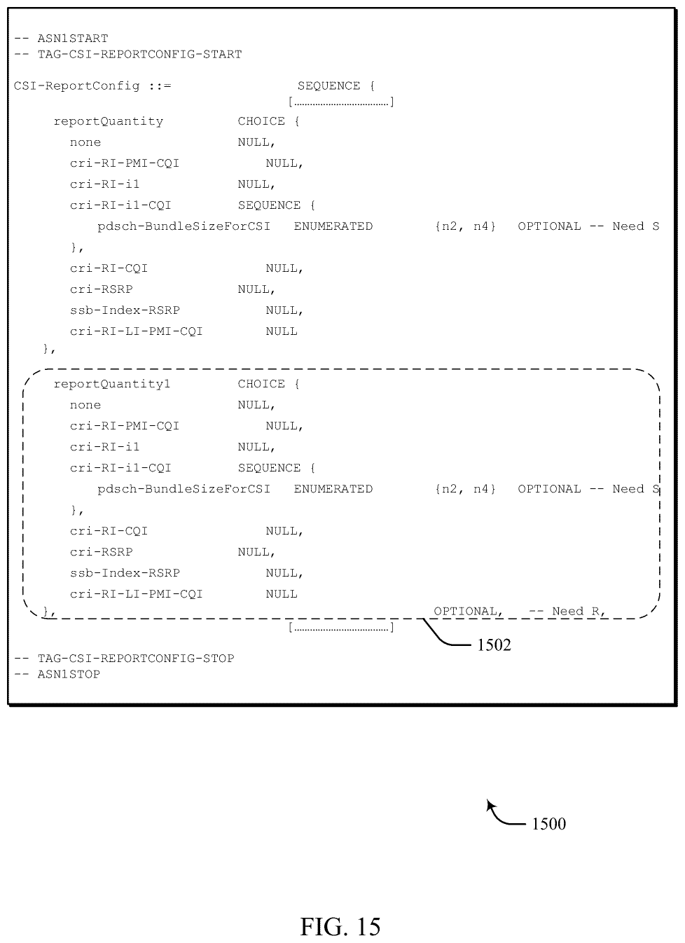

FIG. 15 illustrates an example 1500 of ASN-1 code for an implementation where an event-triggered CSI reporting setting is implicitly indicated by configuring an additional report quantity parameter 1502, which supports event-triggered reporting of CSI in accordance with aspects of the present disclosure. In an example, a second higher-layer parameter corresponding to a second Report quantity, e.g., reportQuantity1, indicates CSI reporting that is associated with event-triggered CSI feedback reporting, if the second higher-layer parameter is configured, which is conditioned on configuring the first higher-layer parameter corresponding to the first report quantity. An Example of the ASN.1 code that corresponds to this scenario is provided in FIG. 15 for the CSI-ReportConfig Reporting Setting Information Element (IE).

In a fourth implementation (e.g., implicit indication via selected CQI table index), the event-triggered CSI feedback reporting is indicated or inferred from a value of a higher-layer parameter corresponding to an index of a CQI table (e.g., cqi-Table) from a set of pre-configured CQI tables.

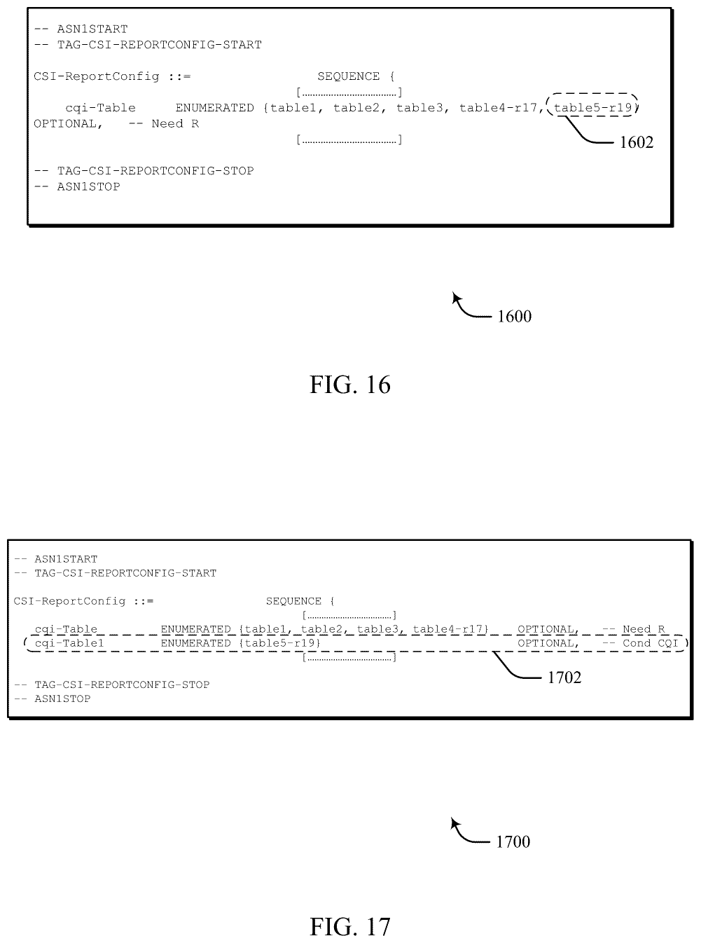

FIG. 16 illustrates an example 1600 of ASN-1 code for an implementation where an event-triggered CSI reporting setting is implicitly indicated by configuring values 1602 of a CQI parameter, which supports event-triggered reporting of CSI in accordance with aspects of the present disclosure. In an example, a value of the higher-layer parameter cqi-Table that corresponds to a codepoint mapped to a CQI table (e.g., table5-r19) associated with event-triggered CSI feedback reporting. For example, the reported CQI in the event-triggered CSI report is selected from the codebook of values of the CQI table associated with event-triggered CSI feedback reporting. An Example of the ASN.1 code that corresponds to this scenario is provided in FIG. 16 for the CSI-ReportConfig Reporting Setting IE.

FIG. 17 illustrates an example 1700 of ASN-1 code for an implementation where an event-triggered CSI reporting setting is implicitly indicated by configuring an additional CQI table parameter 1702, which supports event-triggered reporting of CSI in accordance with aspects of the present disclosure. In an example, a second higher-layer parameter corresponding to a second CQI table, e.g., cqi-Table1, indicates CSI reporting associated with event-triggered CSI feedback reporting, if the second higher-layer parameter is configured, which is conditioned on configuring the first higher-layer parameter corresponding to the first CQI table. An Example of the ASN.1 code that corresponds to this scenario is provided in FIG. 17 for the CSI-ReportConfig Reporting Setting IE. In alternative or additional examples, the two CQI tables correspond to different thresholds of TB error probability.

In a fifth implementation (e.g., inclusion of a CSI-ReportConfig ID corresponding to a full CSI report in the event-triggered CSI reporting setting), a first CSI reporting setting (e.g., CSI-ReportConfig) associated with event-triggered CSI reporting corresponding to partial CSI feedback comprises an identification (ID) of a second CSI reporting setting associated with network-triggered CSI reporting corresponding to full CSI feedback.

Aspects of the present disclosure include solutions for multi-resolution CSI-RS transmission (e.g., two CSI-RS occasions corresponding to: a full CSI reporting; and an event-triggered CSI reporting). In examples, two groups of CSI-RS occasions are configured to be transmitted to a UE, wherein a first of the two groups of the CSI-RS occasions is associated with network-triggered CSI reporting corresponding to full CSI feedback, and a second of the two groups of the CSI-RS occasions is associated with event-triggered CSI reporting corresponding to partial CSI feedback. Several implementations are described below. However, it is noted that additional implementations are possible. For example, one or more elements or features from one or more of the described implementations can be combined in a variety of different ways.

In an implementation (e.g., different transmission occasions of the same CSI-RS resource for full and event-triggered CSI reporting), the first of the two groups of CSI-RS occasions corresponds to a first subset of transmissions of a CSI-RS corresponding to an NZP CSI-RS resource for channel measurement, and the second of the two groups of CSI-RS occasions corresponds to a second subset of transmissions of the CSI-RS corresponding to the NZP CSI-RS resource for channel measurement. In a first example, the second subset of transmissions of the CSI-RS corresponds to every kl transmission of the CSI-RS over time. For instance, the corresponding NZP CSI-RS resource is configured with periodic or semi-persistent time-domain behavior (e.g., k=4), and the first subset of transmissions of the CSI-RS corresponds to a remainder of transmission of the CSI-RS. In a second example, the first subset of transmissions of the CSI-RS is associated with a first frequency density, and the second subset of transmissions of the CSI-RS is associated with a second frequency density.

In an implementation (e.g., different CSI-RS resources for full and event-triggered CSI reporting), a first of two groups of CSI-RS occasions corresponds to a first NZP CSI-RS resource for channel measurement, and a second of the two groups of CSI-RS occasions corresponds to a second NZP CSI-RS resource for channel measurement. In a first example, the second NZP CSI-RS resource for channel measurement is associated with at least one of a fewer number of CSI-RS ports or a smaller frequency density, compared with the first NZP CSI-RS resource for channel measurement. In a second example, a periodicity value of the first NZP CSI-RS resource for channel measurement is larger than or equal to the second NZP CSI-RS resource for channel measurement. In a third example, the periodicity value of the first NZP CSI-RS resource for channel measurement is an integer multiple of the periodicity value of the second NZP CSI-RS resource for channel measurement. In a fourth example, each NZP CSI-RS resource for channel measurement of the first and the second NZP CSI-RS resources for channel measurement is associated with one of periodic CSI-RS transmission or semi-persistent CSI-RS transmission. In a fifth example, the first and the second NZP CSI-RS resources for channel measurement are associated with a same NZP CSI-RS resource set. In a sixth example, the first NZP CSI-RS resource and the second NZP CSI-RS resource are QCLed with respect to Type-A, and Type-D (if applicable).

In an implementation (e.g., different CSI-RS resource sets for full and event-triggered CSI reporting for channel measurement), a first of two groups of CSI-RS occasions corresponds to a first NZP CSI-RS resource set for channel measurement, and a second of the two groups of CSI-RS occasions corresponds to a second NZP CSI-RS resource set for channel measurement. In a first example, a periodicity value of a first CSI-RS transmission associated with the first NZP CSI-RS resource set for channel measurement is larger than or equal to a second CSI-RS transmission associated with the second NZP CSI-RS resource set for channel measurement. In a second example, the periodicity value of the first NZP CSI-RS resource set for channel measurement is an integer multiple of the periodicity value of the second NZP CSI-RS resource set for channel measurement. In a third example, each NZP CSI-RS resource set for channel measurement of the first and the second NZP CSI-RS resource sets for channel measurement is associated with a single NZP CSI-RS resource for channel measurement. In a fourth example, each NZP CSI-RS resource set for channel measurement of the first and the second NZP CSI-RS resource sets for channel measurement is associated with one of periodic CSI-RS transmission or semi-persistent CSI-RS transmission. In a fifth example, a first NZP CSI-RS resource associated with the first NZP CSI-RS resource set and a second NZP CSI-RS resource associated with the second NZP CSI-RS resource set are QCLed with respect to Type-A, and Type-D (if applicable).

In an implementation (e.g., different CSI-RS resources for full and event-triggered CSI reporting for beam measurement), a first of two groups of CSI-RS occasions corresponds to a first NZP CSI-RS resource set that is configured with a higher-layer parameter set to ‘repetition’, and a second of the two groups of CSI-RS occasions corresponds to a second NZP CSI-RS resource set that is configured with a higher-layer parameter set to ‘repetition’. In a first example, the two NZP CSI-RS resource sets share a same NZP CSI-RS resource set ID. In a second example, the second NZP CSI-RS resource set comprises a subset of the NZP CSI-RS resources associated with the first NZP CSI-RS resource set. In a third example, a first NZP CSI-RS resource associated with the first NZP CSI-RS resource set and a second NZP CSI-RS resource associated with the second NZP CSI-RS resource set are QCLed with respect to Type-A, and Type-D (if applicable).

Aspects of the present disclosure include solutions for a CSI report format corresponding to event-triggered CSI reporting (e.g., two groups of CSI report quantities corresponding to full and event-triggered CSI reporting). In at least some implementations, an enhanced CSI framework is provided where a first group of CSI report quantities is associated with a full CSI report and a second group of CSI report quantities is associated with a partial CSI update. In an example, the second group of CSI report quantities corresponding to the partial CSI update is based on the first group of CSI report quantities corresponding to the full CSI report. Several implementations are described below. However, it is noted that additional implementations are possible. For example, one or more elements or features from one or more of the described implementations can be combined in a variety of different ways.

In a first implementation (e.g., two groups of CSI report quantities corresponding to full and event-triggered CSI reporting), the second group of CSI report quantities is a subset of, or the same as, the first group of CSI report quantities. In a first example, the second group of CSI report quantities comprises at least one of RI, PMI, CQI, SSBRI, CRI, L1-RSRP and L1-SINR. In a second example, a first RI value associated with the first group of CSI report quantities is no less than a second RI value associated with the second group of CSI report quantities. In a third example, a first CQI value associated with the first group of CSI report quantities is no less than a second CQI value associated with the second group of CSI report quantities. In a fourth example, a number of beam indices associated with the second group of CSI report quantities is no less than a number of beam indices associated with the second group of CSI report quantities, wherein beam indices are in a form of at least one of CRI, and SSBRI. In a third example, a first L1-RSRP value associated with the first group of CSI report quantities is no less than a second L1-RSRP value associated with the second group of CSI report quantities. In a fourth example, a first L1-SINR value associated with the first group of CSI report quantities is no less than a second L1-SINR value associated with the second group of CSI report quantities.

In a second implementation (e.g., forms of reporting RI value in event-triggered CSI report), the second RI value is reported in the partial CSI update. In a first example, the second RI value is reported via a same bitwidth as that of the first RI value. In a second example, the second RI value is reported via a bitwidth of [log₂ RI₁] bits, wherein [·] operator computes the smallest integer value that is greater than or equal to the operator argument, and RI1 is the first RI value. In a third example, the second RI value is reported via a differential value with respect to the first RI value. In a fourth example, the second RI value is reported via a bitmap of length RI1 bits, wherein a sum of the number of values of one in the bitmap corresponds to the second RI value, and indices of the bitmap of value one indicate indices of layers based on a PMI reported in the first group of CSI report quantities. In a fifth example, the second RI value is reported via a bitmap of length RI1 bits, wherein a sum of the number of values of one in the bitmap corresponds to the second RI value, and indices of the bitmap of value one indicate layer indices based on a PMI reported in the first group of CSI report quantities. In a sixth example, the layer indices are reported in a form of a combinatorial value, wherein the combinatorial value is associated with [log₂ C_{R}_{₂}^{R}^{₁}] bits, where RI2 is the second RI value, C_{b}^{a} is a combinatorial function that takes on values as shown in Table 10, wherein b≤a.

TABLE 10
Values of combinatorial function C_{b}^{a}, where b ≤ a.

| | b = 1 | b = 2 | b = 3 | b = 4 | b = 5 | b = 6 | b = 7 | b = 8 |
|---|---|---|---|---|---|---|---|---|
| a = 1 | 1 | | | | | | | |
| a = 2 | 2 | 1 | | | | | | |
| a = 3 | 3 | 3 | 1 | | | | | |
| a = 4 | 4 | 6 | 4 | 1 | | | | |
| a = 5 | 5 | 10 | 10 | 5 | 1 | | | |
| a = 6 | 6 | 15 | 20 | 15 | 6 | 1 | | |
| a = 7 | 7 | 21 | 35 | 35 | 21 | 7 | 1 | |
| a = 8 | 8 | 28 | 56 | 70 | 56 | 28 | 8 | 1 |

In a third implementation (e.g., forms of reporting CQI value in event-triggered CSI report), the second CQI value is reported in the partial CSI update. In a first example, the second CQI value is reported via a same bitwidth as that of the first CQI value. In a second example, the second CQI value is reported via a bitwidth of [log₂ CQI₁] bits, wherein CQI₁ is the first CQI value. In a third example, the second CQI value is reported in a wideband format, even if the first CQI value is configured with either wideband format or sub-band format. In a fourth example, the second CQI value is reported in a form of a differential value with respect to the first CQI value.

In a fourth implementation (e.g., forms of reporting PMI value in event-triggered CSI report), the second PMI value is reported in the partial CSI update. In a first example, the second PMI value is reported via a same bitwidth as that of the first PMI value. In a second example, the second PMI value comprises updated values of at least one of a set of amplitude coefficient values and a set of phase coefficient values. In a third example, the at least one of the set of amplitude coefficient values and the set of phase coefficient values correspond to beam index or port index that is associated with a strongest coefficient indicated via a strongest coefficient indicator in the first PMI value. In a fourth example, the at least one of the set of amplitude coefficient values and the set of phase coefficient values correspond to beam index or port index that is associated with a layer index indicated via a layer indicator in the first PMI value. In a fifth example, the at least one of the set of amplitude coefficient values and the set of phase coefficient values correspond to beam index or port index that is associated with a set of layer indices indicated via a layer set indicator reported in the partial CSI update corresponding to the second RI value. In a sixth example, the at least one of the set of amplitude coefficient values and the set of phase coefficient values correspond to beam index or port index that is associated with a set of beam (port) indices indicated via a beam (port) indicator reported in the partial CSI update corresponding to the second PMI value.

In a fifth implementation (e.g., forms of reporting TRP index for multiple TRP scenario in event-triggered CSI report), the partial CSI update comprises an indication of a subset of a set of NZP CSI-RS resources for channel measurement. In a first example, the indication of the subset of the set of NZP CSI-RS resources is associated with a CSI reporting setting with a corresponding CSI-RS Resource Set for channel measurement configured with two Resource Groups and N Resource Pairs. In a second example, the indication of the subset of the set of NZP CSI-RS resources is associated with a CSI reporting setting with a corresponding codebook type/sub-type set to a Rel-18 Type-II codebook for CJT, or a Rel-18 Type-II Port-Selection codebook for CJT. In a third example, the indication is in a form of a bitmap of length equal to a number of NZP CSI-RS resources of the set of NZP CSI-RS resources, wherein a value of one in a kl entry of the bitmap implies that the k^{th} NZP CSI-RS resource is included in the subset of NZP CSI-RS resources. In a fourth example, the indication is in a form of a combinatorial value, wherein the combinatorial value is associated with [log₂ C_{M}_{₂}^{M}^{₁}] bits, where M₁, M₂ correspond to the number of NZP CSI-RS resources of the set of NZP CSI-RS resources and the subset of NZP CSI-RS resources, respectively.

In a sixth implementation (e.g., forms of reporting beam index and/or power in event-triggered CSI report), the partial CSI update comprises an indication of a subset of a set of NZP CSI-RS resources corresponding to a NZP CSI-RS resource set configured with a higher-layer parameter ‘repetition’. In a first example, the indication of the subset of the set of NZP CSI-RS resources is based on a CSI report associated with beam reporting corresponding to the first group of report quantities of the full CSI report. In a second example, a bitwidth of reporting an indication one NZP CSI-Rs resource from the set of NZP CSI-RS resources is based on [log₂ B] bits, wherein B is a number of CRI values or SSBRI value reported in the first group of report quantities of the full CSI report. In a third example, the indication is in a form of a bitmap of length equal to a number of NZP CSI-RS resources of the set of NZP CSI-RS resources, wherein a value of one in a k^{th} entry of the bitmap implies that the kl NZP CSI-RS resource is included in the subset of NZP CSI-RS resources. In a fourth example, the indication is in a form of a combinatorial value, wherein the combinatorial value is associated with

$$⌈ {log}_{2} {C}_{{B}_{2}}^{{B}_{1}} ⌉ bits ,$$

where B₁, B₂ correspond to the number of NZP CSI-RS resources of the set of NZP CSI-RS resources and the subset of NZP CSI-RS resources, respectively. In a fifth example, a number of L1-RSRP values, or L1-SINR values, or a combination thereof, reported in a beam report corresponding to the second group of report quantities of partial CSI update is equal to the number of NZP CSI-RS resources of the subset of NZP CSI-RS resources.

In a seventh implementation (e.g., report quantities of event-triggered report are coupled), a first report quantity of the second group of report quantities is associated with a second report quantity of the second group of report quantities. In a first example, an RI value reported in the second group of report quantities of the partial CSI update is associated with a PMI value, CQI value, and/or associated with the second group of report quantities of the partial CSI update. In a second example, a CRI value reported in the second group of report quantities of the partial CSI update is associated with an L1-RSRP value, L1-SINR value, and/or associated with the second group of report quantities of the partial CSI update. In a third example, an SSBRI value reported in the second group of report quantities of the partial CSI update is associated with an L1-RSRP value, L1-SINR value, and/or associated with the second group of report quantities of the partial CSI update. In a fourth example, a first value of a report quantity in the second group of report quantities overrides a second value of a same report quantity in the first group of report quantities (e.g., a first CQI value reported in the second group of report quantities overrides a second CQI value in the first group of report quantities). In a fifth example, a first report quantity of the second group of report quantities and a second report quantity of the second group of report quantities are associated with a measurement of a same channel.

In an eighth implementation (e.g., report quantities of event-triggered report are coupled with those of full CSI report), a first report quantity of the first group of report quantities is associated with a second report quantity of the second group of report quantities. In a first example, a PMI value reported in the first group of report quantities of the full CSI report is associated with an RI value, CQI value, and/or associated with the second group of report quantities of the partial CSI update. In a second example, a PMI value, RI value reported in the first group of report quantities of the full CSI report is associated with a CQI value associated with the second group of report quantities of the partial CSI update. In a third example, a PMI value and/or CQI value reported in the first group of report quantities of the full CSI report is associated with an RI value associated with the second group of report quantities of the partial CSI update. In a fourth example, a first report quantity of the first group of report quantities and a second report quantity of the second group of report quantities are associated with a measurement of a same channel.

In a ninth implementation (e.g., CSI-ReportConfig ID of full CSI report is reported in event-triggered CSI report), the partial CSI update included an ID of a CSI reporting setting, i.e., a CSI-ReportConfig ID, wherein the partial CSI update is based on the full CSI report associated with the CSI reporting setting whose ID is included. In a first example, the partial CSI update associated is based on one full CSI report from a set of full CSI reports associated with a set of CSI report settings. In a second example, the partial CSI update comprises an identification of a CSI reporting setting from the set of CSI reporting settings.

Aspects of the present disclosure include solutions to dedicate UCI resources for event-triggered CSI reports (e.g., UCI resources for reporting event-triggered CSI reports). In implementations, an enhanced resource allocation for UCI bits is provided to support event-triggered CSI reporting corresponding to partial CSI update. Several implementations are described below. In additional or alternative implementations, one or more elements or features from one or more of the described implementations below may be combined in a variety of ways.

In a first implementation (e.g., physical uplink channel for reporting the event-triggered CSI report), an event-triggered CSI report is reported over a physical uplink channel. In a first example, the event-triggered CSI report is fed back over a PUCCH based on periodic CSI reporting. In a second example, the event-triggered CSI report is fed back over PUCCH based on semi-persistent CSI reporting. In a third example, the event-triggered CSI report is fed back over a PUSCH based on semi-persistent CSI reporting. In a fourth example, the event-triggered CSI report is fed back over PUCSH based on aperiodic CSI reporting.

In a second implementation (e.g., event-triggered CSI report is multiplexed with HARQ-ACK based on a NACK), the event-triggered CSI report is multiplexed with HARQ-ACK feedback. In a first example, the event-triggered CSI report is appended to the HARQ-ACK feedback whenever a NACK codepoint of the HARQ-ACK codebook is signaled.

In a third implementation (e.g., UCI overhead of event-triggered CSI report is network-controlled), a number of bits allocated to the event-triggered CSI report is indicated by the network. In a first example, a number of bits allocated to the event-triggered CSI report is configured as part of a corresponding CSI reporting setting. In a second example, a number of bits allocated to the event-triggered CSI report is based on configured report quantities of the second group of report quantities corresponding to the partial CSI update. In a third example, a number of bits allocated to the event-triggered CSI report is based on an indication via MAC CE signaling. In a fourth example, a number of bits allocated to the event-triggered CSI report is based on an indication via DCI signaling, e.g., via a DCI format associated with scheduling PUSCH.

In a fourth implementation (e.g., event-triggered CSI reporting time-domain behavior), an event-triggered CSI report is configured with one of periodic or semi-persistent reporting. In a first example, the event-triggered CSI report is configured with semi-persistent reporting, and a corresponding full, i.e., network-triggered, CSI report is configured with periodic reporting. In a second example, a periodicity of the full CSI report is larger than or equal to a periodicity of the event-triggered CSI report, e.g., the periodicity of the full CSI report is an integer multiple of the periodicity of the event-triggered CSI report.

In a fifth implementation (e.g., different occasions of CSI reporting correspond to full and event-triggered CSI report), two groups of CSI reporting occasions are configured to be transmitted to the UE. In examples, a first of the two groups of CSI reporting occasions is associated with network-triggered CSI reporting corresponding to full CSI feedback, and a second of the two groups of CSI reporting occasions is associated with event-triggered CSI reporting corresponding to partial CSI feedback. In an example, the second group of CSI reporting occasions corresponds to every kl feedback iteration of the CSI feedback reporting, wherein the corresponding CSI reporting is configured with periodic or semi-persistent time-domain behavior, e.g., k=4, and the first group of CSI reporting occasions corresponds to a remainder of CSI reporting iterations.

In a sixth implementation (e.g., indication of presence of event-triggered CSI report), the event-triggered CSI report comprises at least an indicator that identifies whether at least one value of RI, PMI, CQI, CRI, SSBRI, L1-RSRP and L1-SINR report quantity has changed. In examples, the event-triggered CSI report comprises two parts. In a first example, the indicator is in a form of one bit, i.e., binary indicator, in a first of two parts of the event-triggered CSI report. For instance, if a value of the binary indicator is ‘0’, no event-triggered CSI report is generated, whereas if the value of the binary indicator is ‘1’, an event-triggered CSI report is generated. In a second example, the indicator further identifies the report quantity that has changed, e.g., the indicator identifies at least one of a CQI, RI value. In a third example, a presence of fields of the event-triggered CSI report subsequent to the indicator is conditioned on the value of the indicator, e.g., if the indicator identified an event-triggered CSI report is generated, and that a CQI has changed, an updated CSI value is reported. In a fourth example, a presence of a second of the two parts of the event-triggered CSI report is conditioned on the value of the indicator in the first of the two parts of the event-triggered CSI report. In a fifth example, a value of the report quantity that has changed is reported in the second of the two parts of the event-triggered CSI report.

Further aspects of the present disclosure include solutions for event-triggered CSI reporting corresponding to a partial CSI update. Several implementations are described below. In additional or alternative implementations, one or more elements or features from one or more of the described implementations may be combined in a variety of ways.

In an implementation (e.g., event-triggered CSI reporting is based on DMRS for PDSCH), a partial CSI update corresponding to an event-triggered reporting is activated based on the UE being configured with a PDSCH config. In an example, the partial CSI update is based on DMRS for PDSCH associated with the PDSCH transmission that is received at the UE.

In an implementation, a number of CPUs, or simultaneous CSI reports per CC, is expected to take on a maximum value corresponding to a CSI reporting setting that schedules the UE with event-triggered CSI reporting. In an example, if a UE is configured with event-triggered CSI reporting, then the network is configured to avoid sending any further CSI reporting settings until corresponding CSI report is transmitted by the UE.

In an implementation (e.g., Type-I PMI codebook used for event-triggered CSI reporting), a CSI reporting setting that schedules the UE with event-triggered CSI reporting is also expected to configure the UE with a codebook configuration corresponding to a given Type-I single-panel codebook.

In an implementation (e.g., a CSI-RS resource used for event-triggered CSI reporting is counted once), for the purpose of counting a number of CPUs associated with a number of simultaneous CSI measurements, if a CSI-RS resource is referred N times by one or more CSI Reporting Settings, the CSI-RS resource and the CSI-RS ports within the CSI-RS resource are counted N times. In some examples, unless a same CSI-RS resource is referred two times under a same CSI reporting setting corresponding to event-triggered CSI reporting, the CSI-RS resource and the CSI-RS ports within the CSI-RS resource are counted one time. In a first example, a maximum value of the number of the CPUs that the UE can support is reported by the UE. In a second example, a UE is configured by a set of CSI reporting settings associated with k simultaneous CSI measurements, wherein the value of k is constrained by the number of CPUs reported by the UE.

In an implementation (e.g., defining event-triggered CSI reporting), a partial CSI update corresponds to an event-triggered CSI report, and wherein the event corresponds to a modification to a value of at least one of RI, PMI, CQI, CRI, SSBRI, L1-RSRP or L1-SINR.

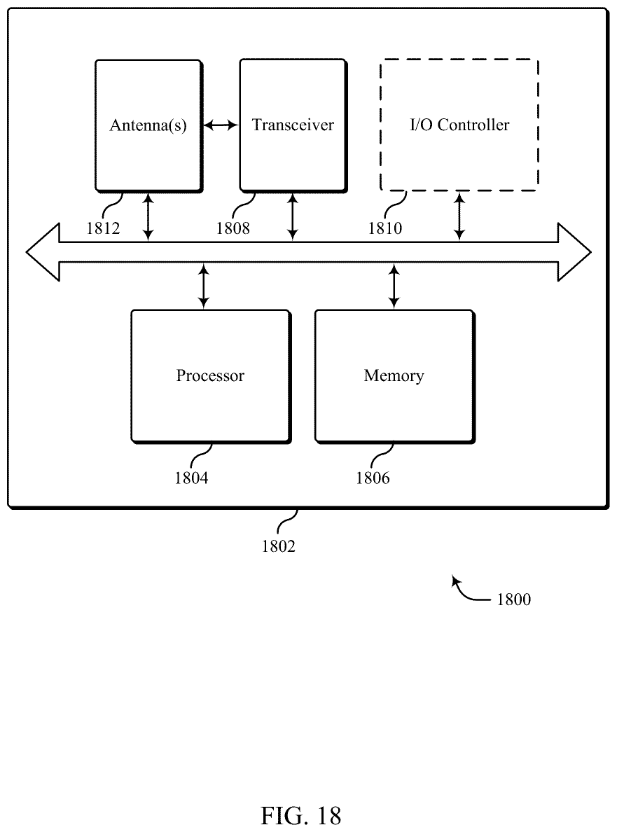

FIG. 18 illustrates an example of a block diagram 1800 of a device 1802 that supports event-triggered reporting of CSI in accordance with aspects of the present disclosure. The device 1802 may be an example of a UE 104 as described herein. The device 1802 may support wireless communication with one or more network entities 102, UEs 104, or any combination thereof. The device 1802 may include components for bi-directional communications including components for transmitting and receiving communications, such as a processor 1804, a memory 1806, a transceiver 1808, and an I/O controller 1810. These components may be in electronic communication or otherwise coupled (e.g., operatively, communicatively, functionally, electronically, electrically) via one or more interfaces (e.g., buses).

The processor 1804, the memory 1806, the transceiver 1808, or various combinations thereof or various components thereof may be examples of means for performing various aspects of the present disclosure as described herein. For example, the processor 1804, the memory 1806, the transceiver 1808, or various combinations or components thereof may support a method for performing one or more of the operations described herein.

In some implementations, the processor 1804, the memory 1806, the transceiver 1808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1804 and the memory 1806 coupled with the processor 1804 may be configured to perform one or more of the functions described herein (e.g., executing, by the processor 1804, instructions stored in the memory 1806).

For example, the processor 1804 may support wireless communication at the device 1802 in accordance with examples as disclosed herein. The processor 1804 may be configured as or otherwise support a means for receiving, from at least one network entity, a first signaling as a CSI reporting setting, the CSI reporting setting including an indication that enables event-triggered CSI reporting over an uplink channel, the event-triggered CSI reporting associated with a first set of report quantities, wherein values of the first set of report quantities are based on values of a second set of report quantities associated with network-triggered CSI reporting; and transmitting a second signaling as a CSI report, the CSI report including the first set of CSI report quantities.

Additionally, the processor 1804 may be configured as or otherwise support any one or combination of the transmitting the second signaling is over a configured set of physical resources associated with the uplink channel. Additionally or alternatively, the event-triggered CSI reporting is associated with a set of DL CSI reference signals based on the CSI reporting setting. Additionally or alternatively, the DL CSI reference signals of the event-triggered CSI reporting correspond to a group of NZP CSI-RS resources associated with the network-triggered CSI reporting. Additionally or alternatively, the group of NZP CSI-RS resources is configured with at least one of: a periodic time-domain configuration, or a semi-persistent time-domain configuration. Additionally or alternatively, a first subset of the DL CSI-RSs is associated with the event-triggered CSI reporting, and a second subset of the DL CSI-RSs is associated with the network-triggered CSI reporting. Additionally or alternatively, the first subset of the DL CSI-RSs and the second subset of the DL CSI-RSs are received in an alternating manner over a set of time units. Additionally or alternatively, the CSI reporting setting further comprises configuration information that enables the network-triggered CSI reporting. Additionally or alternatively, the indication comprises at least one of: a higher-layer configuration parameter in the CSI reporting setting; a higher-layer configuration parameter in a codebook configuration associated with the CSI reporting setting; a selection of a set of CQI tables comprising at least two CQI tables; a report quantity of the CSI reporting setting; or an identification of an additional CSI reporting setting, the additional CSI reporting setting corresponding to the network-triggered CSI reporting. Additionally or alternatively, the CSI report is transmitted over at least one of: a PUSCH based on aperiodic time-domain behavior reporting or semi-persistent time-domain behavior reporting; or a PUCCH based on periodic time-domain behavior reporting or semi-persistent time-domain behavior reporting. Additionally or alternatively, an event associated with the event-triggered CSI reporting comprises a change of a value of at least one CSI report quantity of the second set of CSI report quantities; and the change of the value is indicated in the first set of report quantities. Additionally or alternatively, the first set of CSI report quantities includes a RI value; and the second set of CSI report quantities includes a PMI value and a CQI value. Additionally or alternatively, the first set of CSI report quantities includes a RI value; and the second set of CSI report quantities includes a PMI value and a CQI value. Additionally or alternatively, the first set of CSI report quantities includes a RI value and a CQI value; and the second set of CSI report quantities includes a PMI value. Additionally or alternatively, the first set of CSI report quantities includes a first subset of parameters of a PMI value; and the second set of CSI report quantities includes a second subset of the parameters of the PMI value. Additionally or alternatively, the CSI report of the event-triggered CSI reporting is multiplexed with a HARQ-ACK feedback signal over the uplink channel. Additionally or alternatively, the CSI report being multiplexed HARQ-ACK feedback signal is based on the HARQ-ACK feedback signal corresponding to a NACK signal value. Additionally or alternatively, the event-triggered CSI reporting is configured using at least one of a DCI signal or a MAC-CE signal. Additionally or alternatively, the event-triggered CSI reporting is configured with at least one of: a periodic time-domain configuration, or a semi-persistent time-domain configuration. Additionally or alternatively, a first subset of a set of CSI reporting occasions are associated with the event-triggered CSI reporting, and a second subset of the set of the CSI reporting occasions are associated with the network-triggered CSI reporting. Additionally or alternatively, the first subset of the set of the CSI reporting occasions and the second subset of the set of the CSI reporting occasions are transmitted in an alternating manner over a set of time units. Additionally or alternatively, the CSI report includes at least one part, a first of the at least one part including an indicator of whether the first set of CSI report quantities is present. Additionally or alternatively, the at least one part is two parts based on the indicator having a given value; and a second of the two parts includes the first set of CSI report quantities. Additionally or alternatively, the CSI reporting setting is configured to override one or more other CSI reporting settings received prior to the CSI reporting setting of the first signaling. Additionally or alternatively, wherein a number of CPUs associated with the event-triggered CSI reporting is equal to a maximum number of available CPUs.

Additionally, or alternatively, the device 1802, in accordance with examples as disclosed herein, may include a processor; and a memory coupled with the processor, the processor configured to cause the apparatus to: receive, from at least one network entity, a first signaling as a CSI reporting setting, the CSI reporting setting including an indication that enables an event-triggered CSI reporting by the apparatus over an uplink channel, the event-triggered CSI reporting associated with a first set of report quantities, wherein values of the first set of report quantities are based on values of a second set of report quantities associated with a network-triggered CSI reporting by the apparatus; and transmit a second signaling as a CSI report, the CSI report including the first set of CSI report quantities.

Additionally, the wireless communication at the device 1802 may include any one or combination of the second signaling is transmitted over a configured set of physical resources associated with the uplink channel. Additionally or alternatively, the event-triggered CSI reporting is associated with a set of DL CSI reference signals based on the CSI reporting setting. Additionally or alternatively, the DL CSI reference signals of the event-triggered CSI reporting correspond to a group of NZP CSI-RS resources associated with the network-triggered CSI reporting. Additionally or alternatively, the group of NZP CSI-RS resources is configured with at least one of: a periodic time-domain configuration, or a semi-persistent time-domain configuration. Additionally or alternatively, a first subset of the DL CSI-RSs is associated with the event-triggered CSI reporting, and a second subset of the DL CSI-RSs is associated with the network-triggered CSI reporting. Additionally or alternatively, the first subset of the DL CSI-RSs and the second subset of the DL CSI-RSs are received in an alternating manner over a set of time units. Additionally or alternatively, the CSI reporting setting further comprises configuration information that enables the network-triggered CSI reporting. Additionally or alternatively, the indication comprises at least one of: a higher-layer configuration parameter in the CSI reporting setting; a higher-layer configuration parameter in a codebook configuration associated with the CSI reporting setting; a selection of a set of CQI tables comprising at least two CQI tables; a report quantity of the CSI reporting setting; or an identification of an additional CSI reporting setting, the additional CSI reporting setting corresponding to the network-triggered CSI reporting. Additionally or alternatively, the CSI report is transmitted over at least one of: a PUSCH based on aperiodic time-domain behavior reporting or semi-persistent time-domain behavior reporting; or a PUCCH based on periodic time-domain behavior reporting or semi-persistent time-domain behavior reporting. Additionally or alternatively, an event associated with the event-triggered CSI reporting comprises a change of a value of at least one CSI report quantity of the second set of CSI report quantities; and the change of the value is indicated in the first set of report quantities. Additionally or alternatively, the first set of CSI report quantities includes a RI value; and the second set of CSI report quantities includes a PMI value and a CQI value. Additionally or alternatively, the first set of CSI report quantities includes a RI value; and the second set of CSI report quantities includes a PMI value and a CQI value. Additionally or alternatively, the first set of CSI report quantities includes a RI value and a CQI value; and the second set of CSI report quantities includes a PMI value. Additionally or alternatively, the first set of CSI report quantities includes a first subset of parameters of a PMI value; and the second set of CSI report quantities includes a second subset of the parameters of the PMI value. Additionally or alternatively, the CSI report of the event-triggered CSI reporting is multiplexed with a HARQ-ACK feedback signal over the uplink channel. Additionally or alternatively, the CSI report being multiplexed HARQ-ACK feedback signal is based on the HARQ-ACK feedback signal corresponding to a NACK signal value. Additionally or alternatively, the event-triggered CSI reporting is configured using at least one of a DCI signal or a MAC-CE signal. Additionally or alternatively, the event-triggered CSI reporting is configured with at least one of: a periodic time-domain configuration, or a semi-persistent time-domain configuration. Additionally or alternatively, a first subset of a set of CSI reporting occasions by the apparatus are associated with the event-triggered CSI reporting, and a second subset of the set of the CSI reporting occasions are associated with the network-triggered CSI reporting. Additionally or alternatively, the first subset of the set of the CSI reporting occasions and the second subset of the set of the CSI reporting occasions are transmitted in an alternating manner over a set of time units. Additionally or alternatively, the CSI report includes at least one part, a first of the at least one part including an indicator of whether the first set of CSI report quantities is present. Additionally or alternatively, the at least one part is two parts based on the indicator having a given value; and a second of the two parts includes the first set of CSI report quantities. Additionally or alternatively, the CSI reporting setting is configured to override one or more other CSI reporting settings received at the apparatus prior to the CSI reporting setting of the first signaling. Additionally or alternatively, a number of CPUs associated with the event-triggered CSI reporting is equal to a maximum number of CPUs available at the apparatus.

The processor 1804 of the device 1802, such as a UE 104, may support wireless communication in accordance with examples as disclosed herein. The processor 1804 includes at least one controller coupled with at least one memory, and is configured to or operable to cause the processor to receive, from at least one network entity, a first signaling as a channel state information (CSI) reporting setting, the CSI reporting setting including an indication that enables an event-triggered CSI reporting by a user equipment (UE) over an uplink channel, the event-triggered CSI reporting associated with a first set of report quantities, wherein values of the first set of report quantities are based on values of a second set of report quantities associated with a network-triggered CSI reporting by the UE; and transmit a second signaling as a CSI report, the CSI report including the first set of CSI report quantities.

The processor 1804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1804 may be configured to operate a memory array using a memory controller. In some other implementations, a memory controller may be integrated into the processor 1804. The processor 1804 may be configured to execute computer-readable instructions stored in a memory (e.g., the memory 1806) to cause the device 1802 to perform various functions of the present disclosure.

The memory 1806 may include random access memory (RAM) and read-only memory (ROM). The memory 1806 may store computer-readable, computer-executable code including instructions that, when executed by the processor 1804 cause the device 1802 to perform various functions described herein. The code may be stored in a non-transitory computer-readable medium such as system memory or another type of memory. In some implementations, the code may not be directly executable by the processor 1804 but may cause a computer (e.g., when compiled and executed) to perform functions described herein. In some implementations, the memory 1806 may include, among other things, a basic I/O system (BIOS) which may control basic hardware or software operation such as the interaction with peripheral components or devices.

The I/O controller 1810 may manage input and output signals for the device 1802. The I/O controller 1810 may also manage peripherals not integrated into the device M02. In some implementations, the I/O controller 1810 may represent a physical connection or port to an external peripheral. In some implementations, the I/O controller 1810 may utilize an operating system such as iOS®, ANDROID®, MS-DOS®, MS-WINDOWS®, OS/2®, UNIX®, LINUX®, or another known operating system. In some implementations, the I/O controller 1810 may be implemented as part of a processor, such as the processor 1804. In some implementations, a user may interact with the device 1802 via the I/O controller 1810 or via hardware components controlled by the I/O controller 1810.

In some implementations, the device 1802 may include a single antenna 1812. However, in some other implementations, the device 1802 may have more than one antenna 1812 (i.e., multiple antennas), including multiple antenna panels or antenna arrays, which may be capable of concurrently transmitting or receiving multiple wireless transmissions. The transceiver 1808 may communicate bi-directionally, via the one or more antennas 1812, wired, or wireless links as described herein. For example, the transceiver 1808 may represent a wireless transceiver and may communicate bi-directionally with another wireless transceiver. The transceiver 1808 may also include a modem to modulate the packets, to provide the modulated packets to one or more antennas 1812 for transmission, and to demodulate packets received from the one or more antennas 1812.

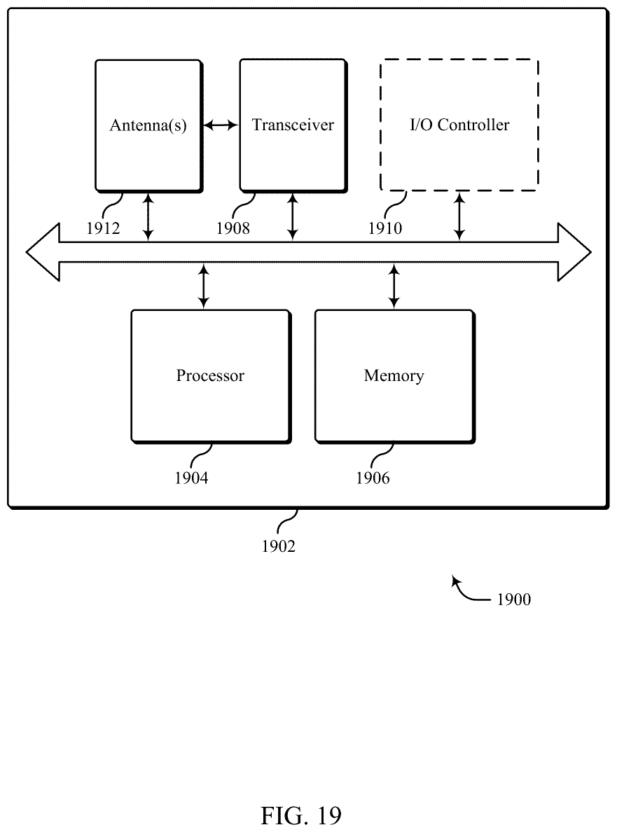

FIG. 19 illustrates an example of a block diagram 1900 of a device 1902 that supports event-triggered reporting of CSI in accordance with aspects of the present disclosure. The device 1902 may be an example of a network entity 102 as described herein. The device 1902 may support wireless communication with one or more network entities 102, UEs 104, or any combination thereof. The device 1902 may include components for bi-directional communications including components for transmitting and receiving communications, such as a processor 1904, a memory 1906, a transceiver 1908, and an I/O controller 1910. These components may be in electronic communication or otherwise coupled (e.g., operatively, communicatively, functionally, electronically, electrically) via one or more interfaces (e.g., buses).

The processor 1904, the memory 1906, the transceiver 1908, or various combinations thereof or various components thereof may be examples of means for performing various aspects of the present disclosure as described herein. For example, the processor 1904, the memory 1906, the transceiver 1908, or various combinations or components thereof may support a method for performing one or more of the operations described herein.

In some implementations, the processor 1904, the memory 1906, the transceiver 1908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1904 and the memory 1906 coupled with the processor 1904 may be configured to perform one or more of the functions described herein (e.g., executing, by the processor 1904, instructions stored in the memory 1906).

For example, the processor 1904 may support wireless communication at the device 1902 in accordance with examples as disclosed herein. The processor 1904 may be configured as or otherwise support a means for transmitting a first signaling as a CSI reporting setting, the CSI reporting setting including an indication that enables event-triggered CSI reporting by a user equipment (UE) over an uplink channel, the event-triggered CSI reporting associated with a first set of report quantities, wherein values of the first set of report quantities are based on values of a second set of report quantities associated with network-triggered CSI reporting by the UE; and receiving, from the UE, a second signaling as a CSI report that includes the first set of CSI report quantities.

Additionally, the processor 1904 may be configured as or otherwise support any one or combination of the receiving the second signaling is over a configured set of physical resources associated with the uplink channel. Additionally or alternatively, the event-triggered CSI reporting is associated with a set of DL CSI reference signals based on the CSI reporting setting. Additionally or alternatively, the DL CSI reference signals of the event-triggered CSI reporting correspond to a group of NZP CSI-RS resources associated with the network-triggered CSI reporting. Additionally or alternatively, the group of NZP CSI-RS resources is configured with at least one of: a periodic time-domain configuration, or a semi-persistent time-domain configuration. Additionally or alternatively, a first subset of the DL CSI-RSs is associated with the event-triggered CSI reporting, and a second subset of the DL CSI-RSs is associated with the network-triggered CSI reporting. Additionally or alternatively, the first subset of the DL CSI-RSs and the second subset of the DL CSI-RSs are received in an alternating manner over a set of time units. Additionally or alternatively, the CSI reporting setting further comprises configuration information that enables the network-triggered CSI reporting by the UE. Additionally or alternatively, the indication comprises at least one of: a higher-layer configuration parameter in the CSI reporting setting; a higher-layer configuration parameter in a codebook configuration associated with the CSI reporting setting; a selection of a set of CQI tables comprising at least two CQI tables; a report quantity of the CSI reporting setting; or an identification of an additional CSI reporting setting, the additional CSI reporting setting corresponding to the network-triggered CSI reporting. Additionally or alternatively, the CSI report is received from the UE over at least one of: a PUSCH based on aperiodic time-domain behavior reporting or semi-persistent time-domain behavior reporting; or a PUCCH based on periodic time-domain behavior reporting or semi-persistent time-domain behavior reporting. Additionally or alternatively, an event associated with the event-triggered CSI reporting includes a change of a value of at least one CSI report quantity of a second set of CSI report quantities associated with the network-triggered reporting; and the change of the value is indicated in the first set of report quantities. Additionally or alternatively, the first set of CSI report quantities includes a CQI value; and the second set of CSI report quantities includes a PMI value and a RI value. Additionally or alternatively, the first set of CSI report quantities includes a RI value; and the second set of CSI report quantities includes a PMI value and a CQI value. Additionally or alternatively, the first set of CSI report quantities includes a RI value and a CQI value; and the second set of CSI report quantities includes a PMI value. Additionally or alternatively, the first set of CSI report quantities includes a first subset of parameters of a PMI value; and the second set of CSI report quantities includes a second subset of the parameters of the PMI value. Additionally or alternatively, the CSI report of the event-triggered CSI reporting is multiplexed with a HARQ-ACK feedback signal over the uplink channel. Additionally or alternatively, the CSI report being multiplexed with the HARQ-ACK feedback signal is based on the HARQ-ACK feedback signal corresponding to a NACK signal value. Additionally or alternatively, the event-triggered CSI reporting is configured using at least one of a DCI signal or a MAC-CE signal. Additionally or alternatively, the event-triggered CSI reporting is configured with at least one of: a periodic time-domain configuration, or a semi-persistent time-domain configuration. Additionally or alternatively, wherein a first subset of a set of CSI reporting occasions is associated with the event-triggered CSI reporting by the UE, and a second subset of the set of the CSI reporting occasions is associated with the network-triggered CSI reporting by the UE. Additionally or alternatively, the first subset of the set of the CSI reporting occasions and the second subset of the set of the CSI reporting occasions are received in an alternating manner over a set of time units. Additionally or alternatively, the CSI report includes at least one part, a first of the at least one part including an indicator of whether the first set of CSI report quantities is present. Additionally or alternatively, the at least one part is two parts based on the indicator having a given value, wherein a second of the two parts includes the first set of CSI report quantities. Additionally or alternatively, the CSI reporting setting is configured to override one or more other CSI reporting settings transmitted to the UE prior to the CSI reporting setting of the first signaling. Additionally or alternatively, a number of CPUs associated with the event-triggered CSI reporting is equal to a maximum number of CPUs available at the UE.

Additionally, or alternatively, the device 1902, in accordance with examples as disclosed herein, may include a processor; and a memory coupled with the processor, the processor configured to cause the apparatus to: transmit a first signaling as a CSI reporting setting, the CSI reporting setting including an indication that enables event-triggered CSI reporting by a user equipment (UE) over an uplink channel, the event-triggered CSI reporting associated with a first set of report quantities, wherein values of the first set of report quantities are based on values of a second set of report quantities associated with network-triggered CSI reporting by the UE; and receive, from the UE, a second signaling as a CSI report that includes the first set of CSI report quantities.

Additionally, the wireless communication at the device 1902 may include any one or combination of the second signaling is received over a configured set of physical resources associated with the uplink channel. Additionally or alternatively, the event-triggered CSI reporting is associated with a set of DL CSI reference signals based on the CSI reporting setting. Additionally or alternatively, the DL CSI reference signals of the event-triggered CSI reporting correspond to a group of NZP CSI-RS resources associated with the network-triggered CSI reporting. Additionally or alternatively, the group of NZP CSI-RS resources is configured with at least one of: a periodic time-domain configuration, or a semi-persistent time-domain configuration. Additionally or alternatively, a first subset of the DL CSI-RSs is associated with the event-triggered CSI reporting, and a second subset of the DL CSI-RSs is associated with the network-triggered CSI reporting. Additionally or alternatively, the first subset of the DL CSI-RSs and the second subset of the DL CSI-RSs are received in an alternating manner over a set of time units. Additionally or alternatively, the CSI reporting setting further comprises configuration information that enables the network-triggered CSI reporting by the UE. Additionally or alternatively, the indication comprises at least one of: a higher-layer configuration parameter in the CSI reporting setting; a higher-layer configuration parameter in a codebook configuration associated with the CSI reporting setting; a selection of a set of CQI tables comprising at least two CQI tables; a report quantity of the CSI reporting setting; or an identification of an additional CSI reporting setting, the additional CSI reporting setting corresponding to the network-triggered CSI reporting. Additionally or alternatively, the CSI report is received from the UE over at least one of: a PUSCH based on aperiodic time-domain behavior reporting or semi-persistent time-domain behavior reporting; or a PUCCH based on periodic time-domain behavior reporting or semi-persistent time-domain behavior reporting. Additionally or alternatively, an event associated with the event-triggered CSI reporting includes a change of a value of at least one CSI report quantity of a second set of CSI report quantities associated with the network-triggered reporting; and the change of the value is indicated in the first set of report quantities. Additionally or alternatively, the first set of CSI report quantities includes a CQI value; and the second set of CSI report quantities includes a PMI value and a RI value. Additionally or alternatively, the first set of CSI report quantities includes a RI value; and the second set of CSI report quantities includes a PMI value and a CQI value. Additionally or alternatively, the first set of CSI report quantities includes a RI value and a CQI value; and the second set of CSI report quantities includes a PMI value. Additionally or alternatively, the first set of CSI report quantities includes a first subset of parameters of a PMI value; and the second set of CSI report quantities includes a second subset of the parameters of the PMI value. Additionally or alternatively, the CSI report of the event-triggered CSI reporting is multiplexed with a HARQ-ACK feedback signal over the uplink channel. Additionally or alternatively, the CSI report being multiplexed with the HARQ-ACK feedback signal is based on the HARQ-ACK feedback signal corresponding to a NACK signal value. Additionally or alternatively, the event-triggered CSI reporting is configured using at least one of a DCI signal or a MAC-CE signal. Additionally or alternatively, the event-triggered CSI reporting is configured with at least one of: a periodic time-domain configuration, or a semi-persistent time-domain configuration. Additionally or alternatively, wherein a first subset of a set of CSI reporting occasions is associated with the event-triggered CSI reporting by the UE, and a second subset of the set of the CSI reporting occasions is associated with the network-triggered CSI reporting by the UE. Additionally or alternatively, the first subset of the set of the CSI reporting occasions and the second subset of the set of the CSI reporting occasions are received in an alternating manner over a set of time units. Additionally or alternatively, the CSI report includes at least one part, a first of the at least one part including an indicator of whether the first set of CSI report quantities is present. Additionally or alternatively, the at least one part is two parts based on the indicator having a given value, wherein a second of the two parts includes the first set of CSI report quantities. Additionally or alternatively, the CSI reporting setting is configured to override one or more other CSI reporting settings transmitted to the UE prior to the CSI reporting setting of the first signaling. Additionally or alternatively, a number of CPUs associated with the event-triggered CSI reporting is equal to a maximum number of CPUs available at the UE.

The processor 1904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1904 may be configured to operate a memory array using a memory controller. In some other implementations, a memory controller may be integrated into the processor 1904. The processor 1904 may be configured to execute computer-readable instructions stored in a memory (e.g., the memory 1906) to cause the device 1902 to perform various functions of the present disclosure.

The memory 1906 may include random access memory (RAM) and read-only memory (ROM). The memory 1906 may store computer-readable, computer-executable code including instructions that, when executed by the processor 1904 cause the device 1902 to perform various functions described herein. The code may be stored in a non-transitory computer-readable medium such as system memory or another type of memory. In some implementations, the code may not be directly executable by the processor 1904 but may cause a computer (e.g., when compiled and executed) to perform functions described herein. In some implementations, the memory 1906 may include, among other things, a basic I/O system (BIOS) which may control basic hardware or software operation such as the interaction with peripheral components or devices.

The I/O controller 1910 may manage input and output signals for the device 1902. The I/O controller 1910 may also manage peripherals not integrated into the device 1902. In some implementations, the I/O controller 1910 may represent a physical connection or port to an external peripheral. In some implementations, the I/O controller 1910 may utilize an operating system such as iOS®, ANDROID®, MS-DOS®, MS-WINDOWS®, OS/2®, UNIX®, LINUX®, or another known operating system. In some implementations, the I/O controller 1910 may be implemented as part of a processor, such as the processor 1904. In some implementations, a user may interact with the device 1902 via the I/O controller 1910 or via hardware components controlled by the I/O controller 1910.

In some implementations, the device 1902 may include a single antenna 1912. However, in some other implementations, the device 1902 may have more than one antenna 1912 (i.e., multiple antennas), including multiple antenna panels or antenna arrays, which may be capable of concurrently transmitting or receiving multiple wireless transmissions. The transceiver 1908 may communicate bi-directionally, via the one or more antennas 1912, wired, or wireless links as described herein. For example, the transceiver 1908 may represent a wireless transceiver and may communicate bi-directionally with another wireless transceiver. The transceiver 1908 may also include a modem to modulate the packets, to provide the modulated packets to one or more antennas 1912 for transmission, and to demodulate packets received from the one or more antennas 1912.

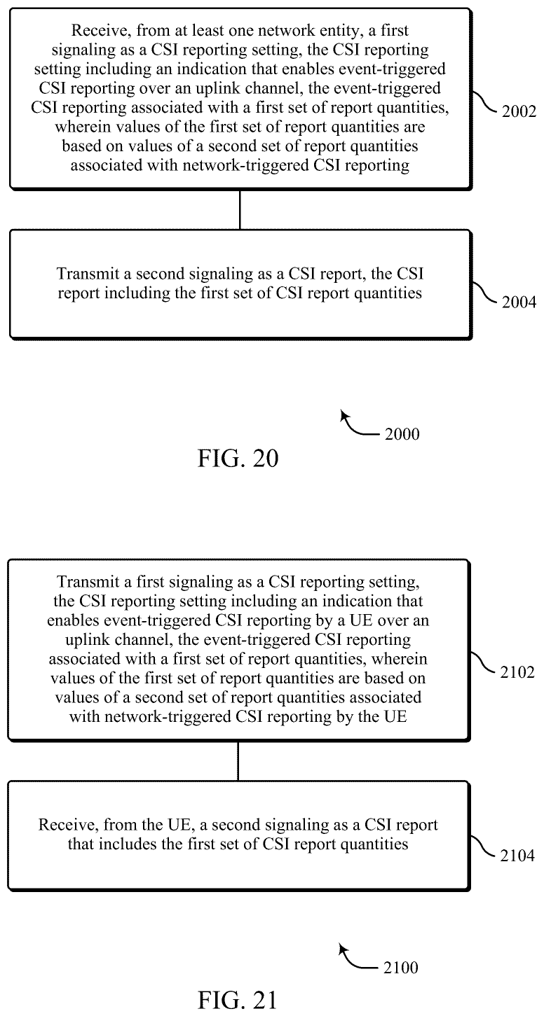

FIG. 20 illustrates a flowchart of a method 2000 that supports event-triggered reporting of CSI in accordance with aspects of the present disclosure. The operations of the method 2000 may be implemented by a device or its components as described herein. For example, the operations of the method 2000 may be performed by a UE 104 as described with reference to FIGS. 1 through 19. In some implementations, the device may execute a set of instructions to control the function elements of the device to perform the described functions. Additionally, or alternatively, the device may perform aspects of the described functions using special-purpose hardware.

At 2002, the method may include receiving, from at least one network entity, a first signaling as a CSI reporting setting, the CSI reporting setting including an indication that enables event-triggered CSI reporting over an uplink channel, the event-triggered CSI reporting associated with a first set of report quantities, wherein values of the first set of report quantities are based on values of a second set of report quantities associated with network-triggered CSI reporting. The operations of 2002 may be performed in accordance with examples as described herein. In some implementations, aspects of the operations of 2002 may be performed by a device as described with reference to FIG. 1.

At 2004, the method may include transmitting a second signaling as a CSI report, the CSI report including the first set of CSI report quantities. The operations of 2004 may be performed in accordance with examples as described herein. In some implementations, aspects of the operations of 2004 may be performed by a device as described with reference to FIG. 1.

FIG. 21 illustrates a flowchart of a method 2100 that supports event-triggered reporting of CSI in accordance with aspects of the present disclosure. The operations of the method 2100 may be implemented by a device or its components as described herein. For example, the operations of the method 2100 may be performed by a network entity 102 as described with reference to FIGS. 1 through 19. In some implementations, the device may execute a set of instructions to control the function elements of the device to perform the described functions. Additionally, or alternatively, the device may perform aspects of the described functions using special-purpose hardware.

At 2102, the method may include transmitting a first signaling as a CSI reporting setting, the CSI reporting setting including an indication that enables event-triggered CSI reporting by a UE over an uplink channel, the event-triggered CSI reporting associated with a first set of report quantities, wherein values of the first set of report quantities are based on values of a second set of report quantities associated with network-triggered CSI reporting by the UE. The operations of 2102 may be performed in accordance with examples as described herein. In some implementations, aspects of the operations of 2102 may be performed by a device as described with reference to FIG. 1.

At 2104, the method may include receiving, from the UE, a second signaling as a CSI report that includes the first set of CSI report quantities. The operations of 2104 may be performed in accordance with examples as described herein. In some implementations, aspects of the operations of 2104 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from at least one network entity, a first signaling as a channel state information (CSI) reporting setting, the CSI reporting setting including an indication that enables an event-triggered CSI reporting by the UE over an uplink channel, the event-triggered CSI reporting associated with a first set of CSI report quantities, wherein values of the first set of CSI report quantities are based on values of a second set of CSI report quantities associated with a network-triggered CSI reporting by the UE; and
transmit a second signaling as a CSI report, the CSI report including the first set of CSI report quantities.

2. The UE of claim 1, wherein the second signaling is transmitted over a configured set of physical resources associated with the uplink channel.

3. The UE of claim 1, wherein the event-triggered CSI reporting is associated with a set of downlink (DL) CSI reference signals based on the CSI reporting setting.

4. The UE of claim 3, wherein the set of DL CSI reference signals of the event-triggered CSI reporting correspond to a group of non-zero power CSI reference signal (NZP CSI-RS) resources associated with the network-triggered CSI reporting, and wherein the group of NZP CSI-RS resources is configured with at least one of a periodic time-domain configuration, or a semi-persistent time-domain configuration.

5. The apparatus of claim 1, wherein the CSI reporting setting further comprises configuration information that enables the network-triggered CSI reporting.

6. The UE of claim 1, wherein the indication comprises one or more of:
a higher-layer configuration parameter in the CSI reporting setting;
the higher-layer configuration parameter in a codebook configuration associated with the CSI reporting setting;
a selection of a set of channel quality indicator (CQI) tables comprising at least two CQI tables;
a report quantity of the CSI reporting setting; or
an identification of an additional CSI reporting setting, the additional CSI reporting setting corresponding to the network-triggered CSI reporting.

7. The UE of claim 1, wherein the CSI report is transmitted over at least one of:
a physical uplink shared channel (PUSCH) based on aperiodic time-domain behavior reporting or semi-persistent time-domain behavior reporting; or
a physical uplink control channel (PUCCH) based on periodic time-domain behavior reporting or the semi-persistent time-domain behavior reporting.

8. The UE of claim 1, wherein:
an event associated with the event-triggered CSI reporting comprises a change of a value of at least one CSI report quantity of the second set of CSI report quantities; and
the change of the value is indicated in the first set of report quantities.

9. The UE of claim 1, wherein:
the first set of CSI report quantities includes a channel quality indicator (CQI) value; and
the second set of CSI report quantities includes a precoder matrix indicator (PMI) value and a rank indicator (RI) value.

10. The UE of claim 1, wherein:
the first set of CSI report quantities includes a rank indicator (RI) value; and
the second set of CSI report quantities includes a precoder matrix indicator (PMI) value and a channel quality indicator (CQI) value.

11. The UE of claim 1, wherein:
the first set of CSI report quantities includes a rank indicator (RI) value and a channel quality indicator (CQI) value; and
the second set of CSI report quantities includes a precoder matrix indicator (PMI) value.

12. The UE of claim 1, wherein:
the first set of CSI report quantities includes a first subset of parameters of a precoder matrix indicator (PMI) value; and
the second set of CSI report quantities includes a second subset of the parameters of the PMI value.

13. The UE of claim 1, wherein the CSI report of the event-triggered CSI reporting is multiplexed with a hybrid automatic repeat request-acknowledgement (HARQ-ACK) feedback signal over the uplink channel.

14. The UE of claim 1, wherein the event-triggered CSI reporting is configured using at least one of a downlink control information (DCI) signal or a medium access control element (MAC-CE) signal.

15. The apparatus of claim 1, wherein the CSI report includes at least one part, a first of the at least one part including an indicator of whether the first set of CSI report quantities is present.

16. The apparatus of claim 15, wherein:
the at least one part is two parts based on the indicator having a given value; and
a second of the two parts includes the first set of CSI report quantities.

17. The apparatus of claim 1, wherein a number of CSI processing units (CPUs) associated with the event-triggered CSI reporting is equal to a maximum number of CPUs available at the apparatus.

18. A processor for wireless communication, comprising:
at least one controller coupled with at least one memory and configured to cause the processor to:
receive, from at least one network entity, a first signaling as a channel state information (CSI) reporting setting, the CSI reporting setting including an indication that enables an event-triggered CSI reporting by a user equipment (UE) over an uplink channel, the event-triggered CSI reporting associated with a first set of CSI report quantities, wherein values of the first set of CSI report quantities are based on values of a second set of CSI report quantities associated with a network-triggered CSI reporting by the UE; and
transmit a second signaling as a CSI report, the CSI report including the first set of CSI report quantities.

19. A network entity (NE) for wireless communication, comprising:
at least one memory; and
at least one processor coupled with the at least one memory and configured to cause the NE to:
transmit a first signaling as a channel state information (CSI) reporting setting, the CSI reporting setting including an indication that enables event-triggered CSI reporting by a user equipment (UE) over an uplink channel, the event-triggered CSI reporting associated with a first set of report quantities, wherein values of the first set of CSI report quantities are based on values of a second set of CSI report quantities associated with a network-triggered CSI reporting by the UE; and
receive, from the UE, a second signaling as a CSI report that includes the first set of CSI report quantities.

20. A method performed by a user equipment (UE), the method comprising:
receiving, from at least one network entity, a first signaling as a channel state information (CSI) reporting setting, the CSI reporting setting including an indication that enables event-triggered CSI reporting over an uplink channel, the event-triggered CSI reporting associated with a first set of CSI report quantities, wherein values of the first set of CSI report quantities are based on values of a second set of CSI report quantities associated with network-triggered CSI reporting; and
transmitting a second signaling as a CSI report, the CSI report including the first set of CSI report quantities.
